(19) United States
(12) Patent Application Publication
(10) Pub. No.: US 2024/0416507 A1
(43) Pub. Date: Dec. 19, 2024

(54) NEW ARCHITECTURE FOR A MOBILE ROBOTIC SYSTEM

(71) Applicant: NIMBLE ONE, ALAN (FR)

(72) Inventor: Titouan LE MAREC, ALAN (FR)

(21) Appl. No.: 18/692,225

(22) PCT Filed: Sep. 14, 2022
(86) PCT No.: PCT/EP2022/075544

§ 371 Date: Aug. 20, 2024

(30) Foreign Application Priority Data
Sep. 15, 2021 (FR) 2109688

(51) Int. Cl. B25J 9/10

(52) U.S. Cl. CPC B25J 9/106

(57) ABSTRACT

A mobile robotic system capable of moving and having N articulated structures connected to one another pairwise in series so as to form a loop. N being a positive integer greater than or equal to 3. Each articulated structure, referred to as a quadrant, having at least two successive limbs, including a first limb referred to as the torso and a last limb. Two successive members of the quadrant being connected to one another by a joint allowing at least one rotation about an axis. A quadrant end joint of the quadrant connecting the last limb of the quadrant to the torso of the next quadrant.

### TECHNICAL FIELD OF THE INVENTION

The invention relates to a new architecture for a mobile robotic system.

### BACKGROUND OF THE INVENTION

The performance of a mobile robot is defined mainly by its architecture and the on-board algorithms. These two components are related, but the capabilities of a mobile robot are mainly defined and limited by its architecture whereas the on-board algorithms allow exploiting the capabilities as best as possible, without extending them.

Among current high-mobility robotic architectures, mention may be made, for example, of biped robots, naturally suited to human environments, by mimicry of the human architecture. The shape of these architectures barely changes and the improvements focus mainly on the control algorithms. One of the main drawbacks of these biped robots relates to their high center of gravity and therefore their low margin of stability, which makes these robots relatively difficult to deploy in the field.

Mention may also be made of multi-legged robots, such as quadrupeds, or articulated vehicles (commonly so-called rovers). In general, these multi-legged robots are in the form of a central base, from which a plurality of articulated legs extend. The central base allows accommodating all of the sensors, the battery and the microcontrollers of these robots. Compared to biped robots, these robots have the advantage of having greater freedom of placement of the legs. In addition, it is possible to install manipulators on these robots either at the legs or at the central base. However, the central base is the main source of limitation of these multi-legged robots because it affects the mobility of the robot. Indeed, since the central base is inert, a trajectory can be followed by a multi-legged robot only if its central base can avoid obstacles located on said trajectory. Thus, only the multi-legged robots with a high central base can cross rocky terrain. Yet, a high central base reduces the stability of the robot because the latter concentrates most of the mass and raises the center of gravity.

The documents CN103303385 and CN105619396 describe examples of architectures of robotic systems including structures articulated pairwise in series, forming a loop.

### OBJECT AND SUMMARY OF THE INVENTION

The present invention aims to overcome the aforementioned drawbacks and provides a new architecture of a robotic system.

To this end, the invention relates to a mobile robotic system, capable of moving, including N articulated structures linked to one another pairwise in series so as to form a loop, N being a positive integer greater than or equal to 3. Each articulated structure, also called quadrant, includes:
at least two successive limbs, including a first limb also called torso, and a last limb;
two successive limbs of the quadrant being linked to one another by a joint enabling at least one rotation about an axis, and
a joint, also called quadrant end joint.

The quadrant end joint of a quadrant links the last limb of said quadrant to the torso of the next quadrant.

Thus, the invention advantageously provides a robotic system whose architecture is composed of quadrants articulated in pairs.

The robotic system allows positioning the quadrants in the space so as to be able to walk, roll, adapt to the terrain on which the robotic system moves. Advantageously, such a robotic system allows increasing the mobility of the robotic system, with regards to the obstacles of the terrain.

The robotic system includes at least three quadrants to advantageously guarantee the static stability of said robotic system in the field. A robotic system with three quadrants is isostatic on any terrain. A system with four quadrants enables the use of one of the torsos as a manipulator while the other three guarantee an isostatic contact with the ground.

Preferably, each quadrant of a robotic system includes the same number of limbs. However, nothing prevents providing a robotic system with quadrants having a different number of limbs.

According to particular embodiments, the robotic system according to the invention further meets the following features, implemented separately or in any of their technically-feasible combinations.

In preferred embodiments of the invention, the robotic system does not include a central body on which each quadrant is linked.

The robotic system has an architecture consisting of quadrants articulated pairwise. Thus, the robotic system, with no central body, proposes an architecture organized only around a main kinematic loop.

Advantageously, the robotic system behaves like a multi-legged robot although it is composed only of multiple quadrants each linked to its two immediate neighbors.

The absence of a central body confers interesting mechanical properties, whether it is:
in terms of mobility and stability, the center of gravity of the robotic system is naturally low.
in terms of mobility and ground clearance: the robotic system having no central body, the ground clearance (i.e. the measurement of the capacity of a vehicle to cross an obstacle) is infinite and the configuration of the robotic system may be adapted to any type of terrain; rocky areas as well as narrow areas are accessible.
in terms of resistance to overturning.

In preferred embodiments of the invention, the robotic system includes actuating means configured to move all or part of the joints of the quadrants. The kinematic loop formed by the successive quadrants linked to one another introduces movement constraints into the robotic system. Advantageously, these movement constraints allow moving all of the joints of the robotic system while only a well-selected subset of the joints is equipped with actuating means. Alternatively, when the actuating means of the robotic system actuate all of the joints of the quadrant, a redundancy is introduced into the actuation of the robotic system which advantageously makes the robotic system robust, in particular following the loss of one or more actuating means.

In preferred embodiments of the invention, at least one quadrant of the robotic system includes a bearing part intended to come into contact with a bearing surface. Preferably, all of the quadrants of the robotic system include a bearing part.

In one example, a bearing part may be a foot, a wheel.

In preferred embodiments of the invention, the robotic system includes at least one locking/unlocking device configured to reversibly detach two successive quadrants. Advantageously, a quadrant detached from one of its neighbors has a much wider accessible movement area. Thus, the quadrant may for example be able to interact with a farther object. The robotic system may also take on a rectilinear shape, for example to negotiate narrow tunnels.

In preferred embodiments of the invention, the robotic system includes, on at least one quadrant, a connector linked, reversibly or not, to one of the limbs of said quadrant, and configured to receive at least one tool. The robotic system may be equipped with a specific tool such as, for example, a vacuum cleaner, a clamp, etc.

In preferred versions of the invention, at least one quadrant of the robotic system includes at least three successive limbs, including:
the torso,
a second limb, also called shoulder, linked to said torso by a joint, also called first joint,
a third limb, also called arm, linked to said shoulder by a joint, also called second joint.

Advantageously, the addition of a limb allows increasing the accessible movement area of the last limb of the quadrant relative to the first limb of the quadrant.

In preferred embodiments of the invention, the first joint of said at least one quadrant enables a rotation about an axis also called first axis, and the second joint enables a rotation about an axis also called second axis, the second axis being orthogonal to said first axis.

In such a configuration, the two joints advantageously reproduce the typical movement of the shoulder/arm assembly of a human body.

In preferred embodiments of the invention, when the at least one quadrant includes only three successive limbs, the arm is the last limb and the quadrant end joint of said quadrant is preferably a ball-joint connection. Advantageously, the ball-joint connection allows achieving a great diversity of movement and can be easily made mechanically.

In preferred embodiments of the invention, the at least one quadrant with at least three successive limbs includes four successive limbs, including:
the torso,
the shoulder, linked to said torso by the first joint,
the arm, linked to said shoulder by the second joint, and
a fourth and last limb, also called forearm, linked to said arm by a joint, also called third joint.

In preferred embodiments, said third joint enables a rotation about an axis also called third axis, said third axis being parallel to said second axis. Preferably, the quadrant end joint of said quadrant with four successive limbs enables a rotation about an axis also called axis of rotation. Said axis of rotation is parallel to the second axis and to the third axis.

In preferred embodiments, the actuating means include an associated motor for each of the joints forming the robotic system.

In preferred embodiments, the actuating means include, at the quadrant with four successive limbs:
a motor configured to drive the first joint of said quadrant,
two motors configured to drive two joints selected from among the second joint, the third joint and the quadrant end joint,
a system of pulleys and belts or cables linking the second joint, the third joint and the quadrant end joint.

In preferred embodiments, the quadrant end joint of the quadrant with four successive limbs:
is a pivot connection linking the last limb of said quadrant with four successive limbs and the torso of the next quadrant, or
includes an auxiliary part, also called pre-torso, linked on the one hand to the last limb of said quadrant with four successive limbs by a pivot connection enabling a rotation about the axis of rotation and, on the other hand, to the torso of the next quadrant by a connection with no degrees of freedom.

In preferred examples, when a quadrant end joint of a quadrant with four successive limbs includes a pre-torso, said quadrant and the next quadrant are configured so as to be able to be reversibly detached, at the connection with no degrees of freedom linking the pre-torso to the torso of said next quadrant.

In preferred embodiments of the invention, said at least one quadrant with at least three successive limbs includes five successive limbs, including:
the torso,
the shoulder, linked to said torso by the first joint,
the arm, linked to said shoulder by the second joint,
a fourth limb, also called forearm, linked to said arm by a joint, also called third joint,
a fifth and last limb, also called wrist, linked to the forearm by a joint, also called fourth joint.

In preferred embodiments, the third joint enables a rotation about an axis also called third axis, said third axis being parallel to said second axis, and the fourth joint enabling a rotation about an axis also called fourth axis, said fourth axis being parallel to said second axis and to said third axis.

In preferred embodiments, the quadrant end joint of said quadrant with five successive limbs enables a rotation about an axis also called axis of rotation. Preferably, the axis of rotation of the quadrant end joint of said quadrant with five successive limbs is parallel to the first axis of the first joint of the next quadrant.

In preferred embodiments, the actuating means include an associated motor for each of the joints forming the robotic system.

In preferred embodiments, the actuating means include, at the quadrant including five successive limbs:
a motor configured to drive the first joint of said quadrant,
two motors configured to drive two joints selected from among the second joint, the third joint and the fourth joint, and
a system of pulleys and belts or cables linking the second joint, the third joint and the fourth joint.

In preferred versions of the invention, at least one quadrant includes at least four successive limbs, including:
the torso,
a second limb, also called shoulder, linked to said torso by a joint, also called first joint,
a third limb, also called arm, linked to said shoulder by a joint, also called second joint,
a fourth limb, also called forearm, linked to said arm by a joint, also called third joint.

Advantageously, the addition of a limb allows increasing the accessible movement area of the last limb of the quadrant relative to the first limb of the quadrant.

In preferred embodiments of the invention, the first joint of said at least one quadrant enables a rotation about an axis also called first axis, the second joint of the quadrant enables a rotation about an axis also called second axis and the third joint enables a rotation about an axis also called third axis. The second axis is orthogonal to said first axis. The third axis is parallel to said second axis.

In preferred embodiments of the invention, the quadrant end joint of said at least one quadrant enables a rotation about an axis also called axis of rotation.

In preferred embodiments of the invention, when the quadrant includes only four successive limbs, the forearm is the last limb of said quadrant, and the axis of rotation is parallel to the second axis and to the third axis.

Thus, the second joint, the third joint and the quadrant end joint of a quadrant advantageously form an RRR-type mechanism: three successive rotations with parallel axes.

Such a mechanism is known per se and can be easily made mechanically.

In preferred embodiments of the invention, the actuating means include an associated motor for each of the joints forming the robotic system.

In preferred embodiments of the invention, the actuating means include, at a quadrant including only four successive limbs:
a motor configured to drive the first joint of the quadrant,
two motors configured to drive two joints selected from among the second joint, the third joint and the quadrant end joint, and
a system of pulleys and belts or cables linking the second joint, the third joint and the quadrant end joint.

Advantageously, such an embodiment allows reducing the number of motors in order to control the joints of the robotic system, and therefore consequently reducing both the weight and the cost of the robotic system.

In preferred embodiments of the invention, the quadrant end joint of the at least one quadrant:
is a pivot connection linking the last limb of said quadrant and the torso of the next quadrant, or
includes an auxiliary part, called the pre-torso, linked on the one hand to the last limb of said quadrant by a pivot connection enabling a rotation about the axis of rotation and, on the other hand, to the torso of the next quadrant by a connection with no degrees of freedom.

In preferred embodiments of the invention, when a quadrant end joint of a quadrant includes a pre-torso, this quadrant and the next quadrant are configured so as to be able to be reversibly detached, at the connection with no degrees of freedom linking the pre-torso to the torso of the next quadrant.

In preferred versions of the invention, at least one quadrant of the robotic system includes at least five successive limbs, including:
the torso,
a second limb, also called shoulder, linked to said torso by a joint, also called first joint,
a third limb, also called arm, linked to said shoulder by a joint, also called second joint,
a fourth limb, also called forearm, linked to said arm by a joint, also called third joint,
a fifth limb, also called wrist, linked to the forearm by a joint, also called fourth joint.

Advantageously, the addition of a limb allows increasing the accessible movement area of the last limb of the quadrant relative to the first limb of the quadrant.

In preferred embodiments of the invention, the first joint of the quadrant enables a rotation about an axis also called first axis, the second joint of the quadrant enables a rotation about an axis also called second axis, the third joint enables a rotation about an axis also called third axis and the fourth joint enabling a rotation about an axis also called fourth axis. The second axis is orthogonal to said first axis, the third axis is parallel to said second axis, and the fourth axis is parallel to said second axis and to said third axis.

In preferred embodiments of the invention, the quadrant end joint of said quadrant enables a rotation about an axis also called axis of rotation.

In preferred embodiments of the invention, the axis of rotation of the quadrant end joint of said quadrant is parallel to the first axis of the first joint of the next quadrant.

Thus, the first and second joints of such a quadrant advantageously replicate the typical movement of the shoulder/arm assembly of a human body. Advantageously, the second and fourth joints form an RRR-type mechanism, which is known per se and which can be easily made mechanically.

In preferred embodiments of the invention, the actuating means include an associated motor for each of the joints forming the robotic system.

In preferred embodiments of the invention, the actuating means include, at a quadrant including five successive limbs:
a motor configured to drive the first joint of the quadrant,
two motors configured to drive two joints selected from among the second joint, the third joint and the fourth joint, and
a system of pulleys and belts or cables linking the second joint, the third joint and the fourth joint.

Advantageously, such an embodiment allows reducing the number of motors in order to control the joints of the robotic system, and therefore consequently reducing both the weight and the cost of the robotic system.

In preferred embodiments of the invention, at least one quadrant of the robotic system includes at least six successive limbs, including:
the torso,
a second limb, also called shoulder, linked to said torso by a joint, also called first joint,
a third limb, also called arm, linked to said shoulder by a joint, also called second joint,
a fourth limb, also called forearm, linked to said arm by a joint, also called third joint,
a fifth limb, also called wrist, linked to the forearm by a joint, also called fourth joint,
a sixth limb, also called hand, linked to the wrist by a joint, also called fifth joint.

Advantageously, the addition of a limb to said at least one quadrant allows increasing the accessible movement area of the last limb relative to the first limb. In addition, said at least one quadrant includes six joints, when counting the quadrant end joint. In such a configuration, by reducing each joint to a pivot connection, said at least one quadrant also advantageously has six degrees of freedom, six degrees of freedom being the minimum number of degrees to enable a complete freedom of positioning in the three-dimensional space. A pivot connection being the simplest connection to be made, the robotic system can be easily made mechanically.

### BRIEF DESCRIPTION OF THE FIGURES

The invention will be better understood upon reading the following description, given as a non-limiting example, and made with reference to the following figures:

FIG. 1 shows a first configuration of a quadrant of a robotic system according to the invention, comprising two limbs;

FIG. 2 illustrates a schematic example of a robotic system comprising three quadrants according to FIG. 1;

FIG. 3 shows a second configuration of a quadrant of a robotic system according to the invention, comprising three limbs;

FIG. 4 illustrates a schematic example of a robotic system comprising three quadrants according to FIG. 3;

FIG. 5 shows a third configuration of a quadrant of a robotic system according to the invention, comprising four limbs;

FIG. 6 illustrates a schematic example of a robotic system comprising four quadrants according to FIG. 5;

FIG. 7 shows a schematic example of the actuating means according to a first embodiment, for a “quadrant-quadrant end joint linking it to the next quadrant” assembly;

FIG. 8 shows an example of the actuating means according to a second embodiment, for a “quadrant-quadrant end joint linking it to the next quadrant” assembly;

FIG. 9 illustrates a perspective view of an example of the shape of the limbs of a quadrant;

FIG. 10 illustrates a perspective view of an example of the arrangement of the limbs for two successive quadrants;

FIG. 11 illustrates a perspective view of another example of the shape of the limbs of a quadrant;

FIG. 12 illustrates another example of a robotic system comprising four quadrants according to the third configuration;

FIG. 13 illustrates an embodiment of a quadrant of the robotic system of FIG. 12;

FIG. 14 shows an exploded view of the quadrant of FIG. 13;

FIG. 15 shows an enlargement of the torso-shoulder assembly of the quadrant of FIG. 13;

FIG. 16 shows two exploded views of the torso-shoulder assembly of FIG. 15;

FIG. 17 shows a variant of the torso-shoulder assembly of the quadrant of FIG. 13;

FIG. 18 shows two exploded views of the torso-shoulder assembly of FIG. 17;

FIG. 19 shows a perspective view of the arm of a quadrant of FIG. 13;

FIG. 20 shows another perspective view of the arm of a quadrant of FIG. 13;

FIG. 21 shows a perspective view of the forearm of a quadrant of FIG. 13;

FIG. 22 shows another perspective view of the forearm of a quadrant of FIG. 13;

FIG. 23 illustrates an example of a locking/unlocking system for detaching the first quadrant from the second quadrant;

FIG. 24 shows an exploded view of the locking/unlocking system of FIG. 23;

FIG. 25 illustrates a torso-shoulder assembly equipped with a wheel assembly;

FIG. 26 shows an exploded view of the torso-shoulder assembly equipped with a wheel assembly of FIG. 25;

FIG. 27 shows an exploded view of a portion of the wheel assembly of FIG. 26;

FIG. 28 shows a fourth configuration of a quadrant of a robotic system according to the invention, comprising five limbs; and

FIG. 29 illustrates a schematic example of a robotic system comprising four quadrants according to FIG. 28.

In these figures, identical reference numerals from one figure to another refer to identical or similar elements. Moreover, for clarity, the drawings are not plotted to scale, unless stated otherwise.

### DETAILED DESCRIPTION OF THE EMBODIMENTS

In the following description, some elements will be designated, for clarity, by terms corresponding to the human body, these elements filling substantially equivalent functions.

Preferably, a robotic system 100 according to the invention is a walker type mobile robotic system. The robotic system 100 is able and intended to move on any type of terrain, even rocky. The robotic system is configured to move by its own means. Advantageously, the robotic system 100 is not fixedly secured to any bearing surface, whether for example the ground or a table.

The robotic system 100 according to the invention includes N articulated structures Q linked to one another pairwise in series. N is a positive integer greater than or equal to 3.

In other words, the robotic system 100 is such that all of the N articulated structures Q form a closed loop.

Preferably, the robotic system 100 is formed only by the N articulated structures. In contrast with existing walking type robotic systems, the robotic system according to the invention does not include any central body on which the articulated structures Q are attached.

In the remainder of the description, an articulated structure is referred to as a quadrant Q.

A minimum number of three quadrants Q is necessary to guarantee the robotic system 100 its static stability on any type of terrain.

Each quadrant Q of the robotic system 100 includes at least two successive limbs. Among these at least two successive limbs is a first limb, also called torso T, and a last limb. Two successive limbs are linked to one another by a joint enabling at least one rotation about an axis.

Each quadrant Q further includes a so-called quadrant end joint.

Preferably, at least two limbs are made of a rigid material, such as for example a plastic, aluminum, stainless steel material or a combination of materials.

In one embodiment, the robotic system according to the invention includes actuating means configured to move all or part of the joints of the quadrants. Preferably, the actuating means are configured to set the assembly of the joints of the quadrants in movement.

In one embodiment of the actuating means, said actuating means include an associated motor for part of the joints of the quadrants of the robotic system. In other words, the robotic system includes fewer motors than joints.

In a preferred embodiment of the actuating means, said actuating means include an associated motor for each of the joints of the quadrants of the robotic system. In other words, the robotic system includes as many motors as joints. In one embodiment, at least one quadrant of the robotic system 100 includes at least one bearing part PA intended to come into contact with a bearing surface, such as for example the ground. The bearing part is linked to one of the at least two limbs of the quadrant, preferably to the torso T of the quadrant.

Preferably, each quadrant Q of the robotic system 100 includes at least one bearing part PA.

In one example, the bearing part includes a foot. The foot is intended to be fixedly linked to one of the at least two limbs of the quadrant. By “fixedly linked”, it should be understood that there is no degree of freedom between the foot and the limb of the quadrant to which it is linked.

In another example of the bearing part, the bearing part PA includes a wheel. The wheel is linked to one of the at least two limbs of the quadrant, preferably to the torso T of the quadrant Q, by a joint enabling one or two degree(s) of freedom.

Examples of a bearing part will be described later on.

In one embodiment (not shown in the figures), the robotic system 100 includes at least one locking/unlocking device configured to reversibly detach two successive quadrants. In other words, the closed loop formed by the quadrants of the robotic system can be opened and closed.

Preferably, the robotic system 100 includes as many locking/unlocking devices as quadrants, which advantageously allows detaching any quadrant of the robotic system, when needed.

Preferably, a locking/unlocking device includes a first fastening element configured to cooperate in a removable manner with a second fastening element. Preferably, the first fastening element is arranged at one of the two successive quadrants and the second fastening element is arranged at the other quadrant.

Preferably, a locking/unlocking device allows disassembling the quadrant end joint of a quadrant.

In one example, the locking/unlocking device is an electromagnetic device.

In another example, the locking/unlocking device is a hybrid device composed of mechanical and electromagnetic elements.

Advantageously, the actuating means are configured to control the at least one locking/unlocking device.

In one embodiment (not shown in the figures), the robotic system 100 includes, on at least one quadrant Q, a connector linked to one of the limbs of said at least one quadrant. The connector is configured to receive at least one tool, such as for example a device for gripping an object, such as a clamp, a suction cup, a flexible membrane, an agricultural tool (such as a harvesting tool, a weeding tool, a sowing tool, etc.), a manufacturing tool (such as a welding tool, a drilling tool, a screwing tool, an assembly tool, etc.), a household care tool (such as a vacuum cleaner, a washing tool, etc.) or a measuring device (such as a temperature, humidity, electromagnetic wave (radio wave or radiation), mechanical (sound, earthquake) sensor), without this list being exhaustive.

The connector is linked, reversibly or not, to said limb of said at least one quadrant.

Preferably, the connector is arranged on a limb of a quadrant which can be detached from the next quadrant.

Preferably, the robotic system includes one connector per quadrant.

In one embodiment (not shown in the figures), the robotic system 100 includes a perception system on at least one quadrant.

Preferably, the robotic system includes a perception system at each quadrant.

In one example, said perception system may include at least one camera, stereo or mono, or any other perceptive sensor such as a lidar, a TOF (Time of Flight) sensor, an ultrasound sensor, an infrared sensor, a touch sensor or an inertial unit, without this list being exhaustive.

When several sensors compose the perception system, these may be grouped together at one single limb of the quadrant or distributed in several limbs of the quadrant.

Five configurations of quadrant will now be described. For each configuration, the number of limbs per quadrant differs.

In the five configurations described, the robotic system includes quadrants all having the same number of limbs. However, it is also possible to make a robotic system which comprises quadrants not all having the same number of limbs.

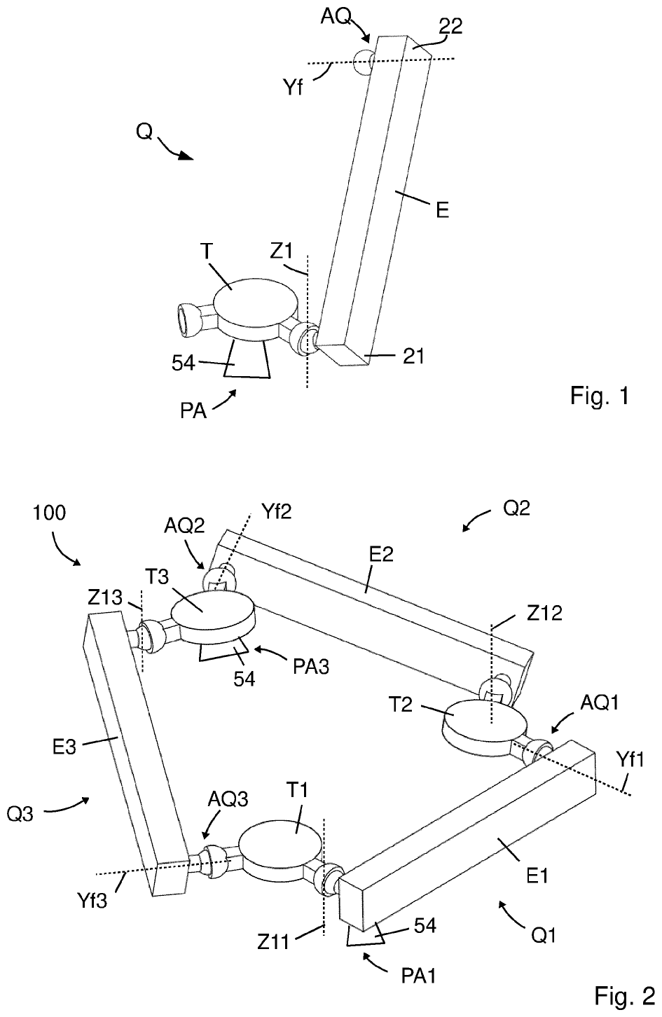

A—Robotic System Including at Least One Quadrant with Two Limbs (FIGS. 1 and 2) In a first configuration, as illustrated in FIG. 1, a quadrant Q of the robotic system 100 includes two successive limbs.

In the non-limiting example of FIG. 2, the robotic system 100 includes three quadrants Q1, Q2, Q3 each including two limbs. Although the quadrants are illustrated in FIG. 1 and described in the number of three, the number of these quadrants is not limited to that described and illustrated. Thus, it is possible to make a robotic system with four quadrants or more, without departing from the scope of the invention.

In general, and as schematically illustrated in FIG. 1, a quadrant Q according to the first configuration successively includes:
a first limb, also called torso T,
a second limb, also called shoulder E.

In this first configuration, the shoulder E thus forms the last limb of the quadrant.

The shoulder E is linked to the torso T by a joint also called first joint. Said first joint enables at least one rotation of an axis also called first axis Z1, as illustrated in FIG. 1.

Preferably, the first joint enables at least three degrees of freedom. Still more preferably, the first joint enables at least three rotations, about three orthogonal axes, including the first axis Z1.

In the example of FIG. 1, the first joint enables three rotations, about three orthogonal axes, including the first axis Z1. In this example, the first joint is a ball-joint connection.

The torso T and the shoulder E of a quadrant may have various shapes, insofar as these shapes do not limit the movement of the shoulder E relative to the torso T, obtained via the first joint.

In a non-restrictive example, illustrated in FIG. 1, the torso T of the quadrant Q is in the form of a generally cylindrical body. The shoulder E of the quadrant Q is in the form of an elongated body. The shoulder E of the quadrant Q has two longitudinal ends, so-called first 21 and second 22 longitudinal ends. The shoulder E is, at its first longitudinal end 21, articulated in rotation with the torso T, via the first joint.

The quadrant end joint AQ of the quadrant Q links the shoulder E of said quadrant to the torso of the next quadrant, as illustrated in FIG. 2. More specifically, the quadrant end joint links the shoulder E of said quadrant, at the second longitudinal end 22, to the torso of the next quadrant.

Preferably, the quadrant end joint AQ enables at least three degrees of freedom. Still more preferably, the quadrant end joint AQ enables at least three rotations, about three orthogonal axes, including an axis also called axis of rotation Yf.

In the example of FIGS. 1 and 2, the quadrant end joint of the quadrant enables three rotations, about three orthogonal axes. In this example, the quadrant end joint is a ball-joint connection.

In one embodiment, when a quadrant Q includes a bearing part PA, said bearing part is preferably linked either to the torso T or to the shoulder E of said at least one quadrant.

In the example of FIG. 1, the bearing part PA is a foot 54.

Returning now to the non-limiting example of FIG. 2, where the robotic system 100 includes three quadrants each comprising two limbs, each quadrant is in the form described hereinabove.

Thus, by analogy, a first quadrant Q1 includes:
a torso T1,
a shoulder E1, linked to the torso T1 by a first joint enabling a rotation about a first axis Z11.

A second quadrant Q2 includes:
a torso T2,
a shoulder E2, linked to the torso T2 by a first joint enabling at least one rotation about a first axis Z12.

A third quadrant Q3 includes:
a torso T3,
a shoulder E3, linked to the torso T3 by a first joint enabling at least one rotation about a first axis Z13.

The first quadrant Q1 includes a quadrant end joint AQ1 linking it to the second quadrant Q2. Said quadrant end joint AQ1 of the first quadrant Q1 enables at least one rotation about an axis of rotation Yf1.

The second quadrant Q2 includes a quadrant end joint AQ2 linking it to the third quadrant Q3. Said quadrant end joint AQ2 of the second quadrant enables at least one rotation about an axis of rotation Yf2.

The third quadrant Q3 includes a quadrant end joint AQ3 linking it to the fourth quadrant Q4. Said quadrant end joint AQ3 of the third quadrant Q3 enables at least one rotation about an axis of rotation Yf3.

Preferably, the actuating means are configured to move all or part of the joints of the quadrants of the robotic system 100 and ensure the movement of said robotic system on any type of terrain.

In one embodiment (not shown), when the robotic system 100 includes, on at least one quadrant, a connector configured to receive a tool, said connector is preferably arranged on the shoulder of said at least one quadrant, for example at its second end 22.

In one embodiment, when the robotic system 100 includes, on at least one quadrant, a bearing part, said bearing part may be linked either to the torso or to the shoulder.

In the non-limiting example of FIG. 2, the first quadrant Q1 includes a bearing part PA1, in the form of a foot 54, linked to the shoulder E1, preferably at the first end of said shoulder. The third quadrant Q3 includes a bearing part PA3, in the form of a foot 54, linked to the torso T3.

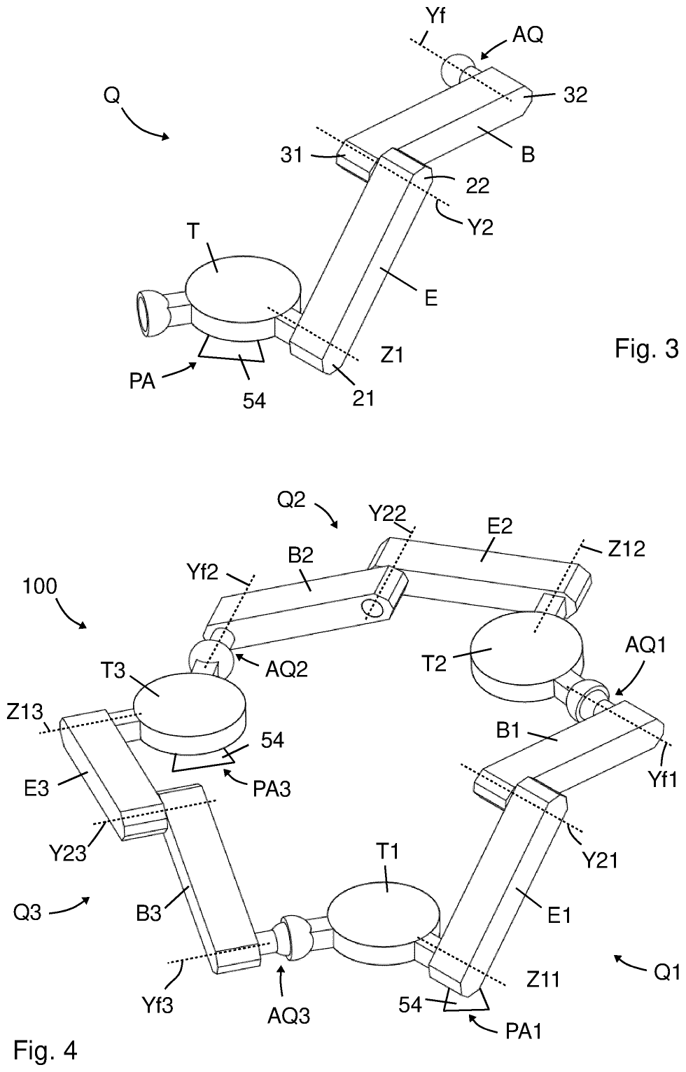

B—Robotic System Including at Least One Quadrant with Three Limbs (FIGS. 3 and 4)

In a second configuration, as illustrated in FIG. 3, a quadrant Q of the robotic system 100 includes three successive limbs.

In the non-limiting example of FIG. 4, the robotic system 100 includes three quadrants Q1, Q2, Q3 each including three limbs. Although the quadrants are illustrated in FIG. 4 and described in the number of three, the number of these quadrants is not limited to that described and illustrated. Thus, it is possible to make a robotic system with four quadrants or more, without departing from the scope of the invention.

This second configuration replicates all of the elements (limbs, joints) described in the first configuration.

Thus, in general, and as schematically illustrated in FIG. 3, a quadrant Q according to the second configuration successively includes, besides the torso T and the shoulder E, a third limb also called arm B.

In this second configuration, the arm B thus forms the last limb of the quadrant Q.

Like for the first configuration, the shoulder E is linked to the torso T by the first joint. Said first joint enables at least one rotation with a first axis Z1.

Preferably, and as illustrated in FIG. 3, the first joint enables only a rotation about the first axis Z1.

The arm B is linked to the shoulder E by a joint, called second joint. Said second joint enables at least one rotation about an axis also called second axis Y2.

Preferably, the second axis Y2 is parallel to the first axis Z1.

Preferably, and as illustrated in FIG. 3, the second joint enables only a rotation about the second axis Y2.

The torso T, the shoulder E and the arm B of a quadrant Q may have various shapes, insofar as these shapes do not limit the movement of the shoulder E relative to the torso T, obtained via the first joint, or the movement of the arm B relative to the shoulder E, obtained via the second joint.

In a non-restrictive example embodiment, illustrated in FIG. 3, the torso T of the quadrant Q is in the form of a generally cylindrical body.

Preferably, each of the shoulder E and the arm B of the quadrant Q is in the form of an elongate body. Preferably, the shoulder E and the arm B have substantially identical shapes.

Preferably, the shoulder E and the arm B have substantially the same length.

Each of the shoulder E and the arm B of the quadrant Q has two longitudinal ends, so-called first and second longitudinal ends 21, 22.

At its first longitudinal end 21, the shoulder E is articulated in rotation with the torso T, via the first joint, at least about the first axis Z1.

Preferably, the first axis Z1 extends orthogonally to the elongated body of the shoulder E, in the direction of a thickness of said elongated body.

At its second longitudinal end 22, the shoulder E is articulated in rotation with the arm B, at the first longitudinal end 31 of said arm B, via the second joint, about the second axis Y2.

Preferably, the second axis Y2 extends orthogonally to the elongated body of the shoulder E, and to the elongated body of the arm B, in the direction of a thickness of the shoulder and of the arm.

Preferably, when the first and second joints of the quadrant Q enables only a rotation about one axis, each of the first and second joints is made by a pivot connection, for example by means of a plain bearing or ball bearings. It is also possible to make the second joint of the quadrant from a combination of two pivot connections with the same axis.

Such pivot connection embodiments are conventional and known to a person skilled in the art and will not be described in more detail.

The quadrant end joint AQ of the quadrant Q links the arm B of said quadrant to the torso of the next quadrant, as illustrated in FIG. 4. More specifically, the quadrant end joint of the quadrant Q links the arm of said quadrant, at its second longitudinal end 32, to the torso of the next quadrant.

Preferably, the quadrant end joint AQ of the quadrant Q enables at least three degrees of freedom. Still more preferably, the quadrant end joint AQ of the quadrant Q enables at least three rotations, about three orthogonal axes, including an axis of rotation Yf. Said axis of rotation Yf is parallel to the second axis.

In the example of FIGS. 3 and 4, the quadrant end joint of the quadrant enables three rotations, about three orthogonal axes. Preferably, the quadrant end joint of the quadrant is made by a ball-joint connection.

In one embodiment, when a quadrant Q includes a bearing part PA, said bearing part is preferably linked either to the torso T, or to the shoulder E of said at least one quadrant.

In the example of FIG. 3, the bearing part PA is a foot 54.

Returning now to the non-limiting example of FIG. 4, where the robotic system 100 includes three quadrants each comprising three limbs, each quadrant is in the form described hereinabove.

Thus, by analogy, a first quadrant Q1 includes:
a torso T1,
a shoulder E1, linked to the torso T1 by a first joint enabling a rotation about a first axis Z11,
an arm B1, linked to the shoulder E1 by a second joint enabling a rotation about a second axis Y21.

The axes Z11 and Y21 are parallel.

A second quadrant Q2 includes:
a torso T2,
a shoulder E2, linked to the torso T2 by a first joint enabling a rotation about a first axis Z12,
an arm B2, linked to the shoulder E2 by a second joint enabling a rotation about a second axis Y22.

The axes Z12 and Y22 are parallel.

A third quadrant Q3 includes:
a torso T3,
a shoulder E3, linked to the torso T3 by a first joint enabling a rotation about a first axis Z13,
an arm B3, linked to the shoulder E3 by a second joint enabling a rotation about a second axis Y23.

The axes Z13 and Y23 are parallel.

The first quadrant Q1 includes a quadrant end joint AQ1 linking it to the second quadrant Q2. Said joint AQ1 of the first quadrant Q1 enables at least one rotation about an axis of rotation Yf1. The axis of rotation Yf1 is parallel to the second axis Y21.

The second quadrant Q2 includes a quadrant end joint AQ2 linking it to the third quadrant Q3. Said quadrant end joint of the second quadrant Q2 enables at least one rotation about an axis of rotation Yf2. The axis of rotation Yf2 is parallel to the second axis Y22.

The third quadrant Q3 includes a quadrant end joint AQ3 linking it to the fourth quadrant Q4. Said quadrant end joint AQ3 of the third quadrant Q3 enables at least one rotation about an axis of rotation Yf3. The axis of rotation Yf3 is parallel to the second axis Y23.

In the example of FIG. 4, Yf1 and Z11 are parallel, Yf2 and Z12 are parallel, Yf3 and Z23 are parallel.

Preferably, the quadrant end joint AQ1 of the first quadrant Q1, the quadrant end joint AQ2 of the second quadrant Q2, and the quadrant end joint AQ3 of the third quadrant Q3 are made by a ball-joint connection.

Preferably, the actuating means are configured to move all or part of the joints of the quadrants of the robotic system 100 and ensure the movement of said robotic system on any type of terrain.

In one embodiment (not shown), when the robotic system 100 includes, on at least one quadrant, a connector configured to receive a tool, said connector is preferably arranged on the arm of said at least one quadrant, for example at its second end 22.

In one embodiment, when the robotic system 100 includes, on at least one quadrant, a bearing part, said bearing part may be linked either to the torso or to the shoulder.

In the non-limiting example of FIG. 4, the first quadrant Q1 includes a bearing part PA1, in the form of a foot 54, linked to the shoulder E1, preferably at the first end of said shoulder. The third quadrant Q3 includes a bearing part PA3, in the form of a foot 54, linked to the torso T3.

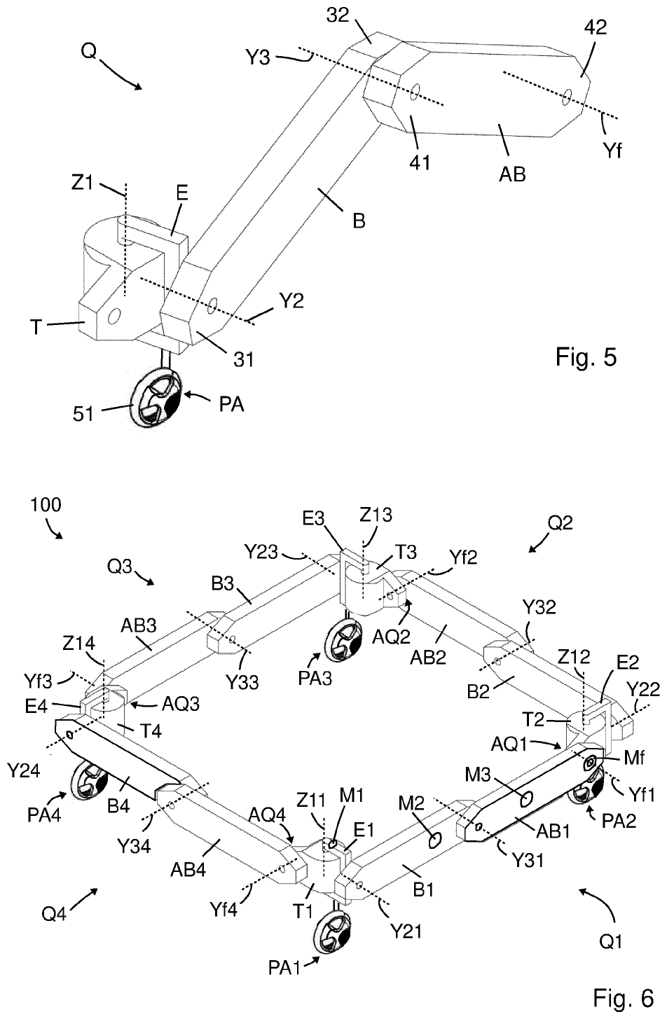

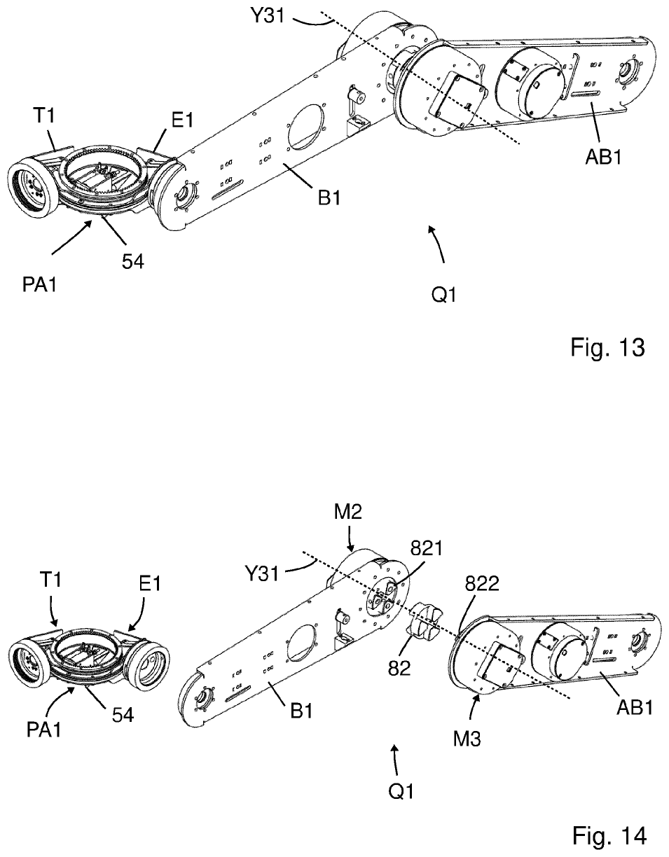

C—Robotic System Including at Least One Quadrant with Four Limbs (FIGS. 5 and 13)

In a third configuration, as illustrated in FIG. 5, a quadrant Q of the robotic system 100 includes four successive limbs.

In the non-limiting example of FIG. 6, the robotic system 100 includes four quadrants Q1, Q2, Q3, Q4, each including four limbs. Although the quadrants are illustrated in FIG. 6 and described in the number of four, the number of these quadrants is not limited to that described and illustrated. Thus, it is possible to make a robotic system with three quadrants, five quadrants or more, without departing from the scope of the invention.

This third configuration replicates all of the elements (limbs, joints) described in the second configuration.

Thus, in general, and as schematically illustrated in FIG. 5, a quadrant Q according to the third configuration successively includes, besides the torso T, the shoulder E and the arm B, a fourth limb, also called forearm AB.

In this third configuration, the forearm AB thus forms the last limb of the quadrant Q.

Like for the first and second configurations, the shoulder E is linked to the torso T by the first joint. Said first joint enables at least one rotation with a first axis Z1.

Preferably, and as illustrated in FIG. 5, the first joint enables only a rotation about the first axis Z1.

The arm B is linked to the shoulder E by the second joint. Said second joint enables at least one rotation about a second axis Y2. Preferably, the second axis Y2 is orthogonal to the first axis Z1.

Preferably, and as illustrated in FIG. 5, the second joint enables only a rotation about the second axis Y2.

The forearm AB is linked to the arm B by a joint, also called third joint. Said third joint enables at least one rotation about an axis also called third axis Y3. Preferably, the third axis Y3 is parallel to the second axis Y2.

Preferably, and as illustrated in FIG. 5, the third joint enables only a rotation about the third axis Y3.

The torso T, the shoulder E, the arm B and the forearm AB of a quadrant Q may have various shapes, insofar as these shapes do not limit the movement of the shoulder E relative to the torso T, obtained via the first joint, or the movement of the arm relative to the shoulder E, obtained via the second joint, or the movement of the forearm AB relative to the arm B, obtained via the third joint.

In a preferred embodiment, illustrated in FIG. 5, each of the arm B and the forearm AB of the quadrant Q is in the form of an elongate body. Preferably, the arm B and the forearm AB have substantially identical shapes. Preferably, the arm B and the forearm AB have substantially the same length.

Each of the arm B and the forearm AB of the quadrant Q has two longitudinal ends, so-called first and second longitudinal ends.

At its first longitudinal end 31, the arm B is articulated in rotation with the shoulder E about the second axis Y2, via the second joint. Preferably, the second axis Y2 extends orthogonally to the elongated body of the arm, in the direction of a thickness of said elongated body.

At its second longitudinal end 32, the arm B is articulated in rotation with the forearm AB, at the first longitudinal end 41 of said forearm AB, about the third axis Y3, via the third joint.

Preferably, the third axis Y3 extends orthogonally to the elongated body of the arm B, and to the elongated body of the forearm AB, in the direction of a thickness of the forearm and of the arm.

Examples of variants of a torso T and of a shoulder E will be described later on.

Preferably, each of the first, second and third joints of the quadrant Q is made by a pivot connection, for example by means of a plain bearing or ball bearings. It is also possible to make the third joint of the quadrant from a combination of two pivot connections with the same axis.

The quadrant end joint AQ of the quadrant Q links the forearm of said quadrant to the torso of the next quadrant. More specifically, said quadrant end joint AQ links the forearm AB of the quadrant, at its second end 42, to the torso of the next quadrant.

Said quadrant end joint AQ enables at least one rotation about an axis of rotation Yf. Said axis of rotation is parallel to the second axis of the second joint of the quadrant and to the third axis of the third joint of the quadrant. In other words, the second axis, the third axis and the axis of rotation Yf of a quadrant Q are parallel to one another.

Preferably, as illustrated in FIG. 6, the quadrant end joint AQ of the quadrant Q according to the third configuration enables only a rotation about the axis of rotation Yf.

Besides the fact that it should not limit the rotation about the first axis Z1 of the torso T relative to the shoulder E, by the first joint, the shape of the torso T of the quadrant Q according to the third configuration should not also limit the rotation about the axis of rotation Yf of the forearm of the preceding quadrant relative to said torso of the quadrant, by the quadrant end joint of the quadrant.

In one embodiment of a quadrant end joint AQ, said quadrant end joint AQ is made by a pivot connection between the forearm of the quadrant and the torso of the next quadrant, for example by means of a plain bearing or ball bearings.

In another embodiment of a quadrant end joint AQ, said quadrant end joint AQ is made from a combination of a pivot connection and a fixed connection, with no degrees of freedom.

In a preferred example of this embodiment, not shown, the quadrant end joint of a quadrant includes an auxiliary part, also called pre-torso, located between the pivot connection and the fixed connection. Thus, the pre-torso is linked on the one hand to the forearm of the quadrant by the pivot connection enabling a rotation about the axis of rotation Yf and, on the other hand, to the torso of the next quadrant by a connection with no degrees of freedom.

In one embodiment, when a quadrant Q includes a bearing part PA, said bearing part PA is preferably linked either to the torso T or to the shoulder E of the quadrant.

In the non-limiting example of FIG. 5, the bearing part PA is linked to the shoulder E. In an example (not shown) of the bearing part, the bearing part PA includes a foot, fixedly linked to the torso or to the shoulder. In other words, there is no degree of freedom between the foot and the torso or the shoulder.

In another embodiment of the bearing part, as illustrated in FIG. 5, the bearing part PA includes a wheel 51. The wheel 51 is linked to the torso T or to the shoulder E, by a joint enabling one or two degree(s) of freedom. In the case where the wheel 51 is linked to the torso T or to the shoulder E by a joint with one degree of freedom, the degree of freedom is according to the axis of the wheel so that the latter could rotate about its axis. In the case where the wheel is linked to the torso or to the shoulder by a joint with two degrees of freedom, a first degree of freedom is according to the axis of the wheel so that the latter could rotate about its axis and a second degree of freedom according to the first axis Z1 in order to be able to orient the wheel.

Other embodiments of a bearing part will be described later on. Returning now to the example of FIG. 6, where the robotic system 100 includes four quadrants each including four limbs, each quadrant is in the form described hereinabove.

Thus, by analogy, a first quadrant Q1 includes:
a torso T1,
a shoulder E1, linked to the torso T1 by a first joint enabling a rotation about a first axis Z11,
an arm B1, linked to the shoulder E1 by a second joint enabling a rotation about a second axis Y21,
a forearm AB1, linked to the arm B1 by a third joint enabling a rotation about a third axis Y31.

The axes Z11 and Y21 are orthogonal. The axes Y21 and Y31 are parallel.

A second quadrant Q2 includes:
a torso T2,
a shoulder E2, linked to the torso T2 by a first joint enabling a rotation about a first axis Z12,
the arm B2, linked to the shoulder E2 by a second joint enabling a rotation about a second axis Y22,
a forearm AB2, linked to the arm B2 by a third joint enabling a rotation about a third axis Y32.

The axes Z12 and Y22 are orthogonal. The axes Y22 and Y32 are parallel.

A third quadrant Q3 includes:
a torso T3,
a shoulder E3, linked to the torso T3 by a first joint enabling a rotation about a first axis Z13,
the arm B3, linked to the shoulder E3 by a second joint enabling a rotation about a second axis Y23,
a forearm AB3, linked to the arm B3 by a third joint enabling a rotation about a third axis Y33.

The axes Z13 and Y23 are orthogonal. The axes Y23 and Y33 are parallel.

A fourth quadrant Q4 includes:
a torso T4,
a shoulder E4, linked to the torso T4 by a first joint enabling a rotation about a first axis Z14,
the arm B4, linked to the shoulder E4 by a second joint enabling a rotation about a second axis Y24,
a forearm AB4, linked to the arm B4 by a third joint enabling a rotation about a third axis Y34.

The axes Z14 and Y24 are orthogonal. The axes Y24 and Y34 are parallel.

The first quadrant Q1 includes a quadrant end joint AQ1 linking it to the second quadrant Q2. Said quadrant end joint AQ1 of said first quadrant enables at least one rotation about an axis of rotation Yf1, said axis of rotation Yf1 being parallel to the second axis Y21 and to the third axis Y31 of the first quadrant Q1.

The second quadrant Q2 includes a quadrant end joint AQ2 linking it to the third quadrant Q3. Said quadrant end joint AQ2 of said second quadrant enables at least one rotation about an axis of rotation Yf2, the axis of rotation Yf2 being parallel to the second axis Y22 and to the third axis Y32 of the second quadrant Q2.

The third quadrant Q3 includes a quadrant end joint AQ3 linking it to the fourth quadrant Q4. Said quadrant end joint AQ3 of said third quadrant enables at least one rotation about an axis of rotation Yf3, the axis of rotation Yf3 being parallel to the second axis Y23 and to the third axis Y33 of the third quadrant Q3.

Finally, the fourth quadrant Q4 includes a quadrant end joint AQ4 linking it to the first quadrant Q1. Said quadrant end joint AQ4 of the fourth quadrant Q4 enables only a rotation about an axis of rotation Yf4, the axis of rotation Yf4 being parallel to the second axis Y24 and to the third axis Y34 of the fourth quadrant Q4.

Preferably, the actuating means are configured to move all of the joints of the robotic system and ensure the movement of said robotic system on any type of terrain.

In a first embodiment of the actuating means, said actuating means include, for each of the joints of the quadrants of the robotic system, an associated motor. Each motor is able to apply a rotational movement between the two limbs linked by the associated joint.

In an exemplary embodiment of this first embodiment, for the first quadrant, as illustrated in FIG. 6:
a first motor M1 is intended to drive and move the shoulder E1 relative to the torso T1 about the first axis Z11,
a second motor M2 is intended to drive and move the arm B1 relative to the shoulder E1 about the second axis Y21,
a third motor M3 is intended to drive and move the forearm AB1 relative to the arm B1 about the third axis Y31,
a fourth motor Mf is intended to drive and move the torso T2 of the second quadrant Q2 relative to the forearm AB1 of the first quadrant Q1 about the axis of rotation Yf1.

In such a first embodiment, each joint is thus controlled independently of one another.

In the example of FIG. 6, where the robotic system includes four quadrants, and four limbs per quadrant, the robotic system includes sixteen joints and therefore sixteen motors.

It is clear that the actuation of the joints can be obtained by any suitable type of motor, like, for example, alternating-current electric motors, direct-current motors, a pneumatic system, direct current combustion engines.

Preferably, the motor is either arranged at the associated joint or is offset therefrom.

In one example, illustrated in FIG. 6, the second motor M2 associated with the second joint of the first quadrant Q1 may be offset in the arm B, for example at mid-length.

Moreover, each motor is preferably provided with a measuring device (not shown), or sensor, intended to measure the evolution of the state of said motor and therefore of the associated joint. For so-called rotary motors, the sensor preferably gives access to the angle and the rotational speed between the two associated limbs, therefore the movements of said two limbs driven thereby, so as to provide a suitable control response.

The measuring devices may be of any suitable type, such as, for example, optical encoders, potentiometers, Hall effect sensors.

In a second embodiment, said actuating means include an associated motor for part of the joints of the quadrants of the robotic system. Advantageously, by reducing the number of motors for driving all of the joints of the quadrants of the robotic system, such an embodiment allows reducing both the weight and the cost of the robotic system.

In a first exemplary embodiment of this second embodiment, the non-motor-driven joints are free and move under the effect of the movements of the other limbs and of the external environment.

In a second exemplary embodiment of this second embodiment, the non-motor-driven joints are linked to motor-driven joints via a constraint system.

The actuating means include, for example for the first quadrant Q1:
a first motor M1 configured to drive the first joint of the first quadrant Q1, by moving the shoulder E1 relative to the torso T1 in rotation about the first axis Z11,
two motors M2, M3, configured to drive two joints selected from among the second joint of the first quadrant Q1, the third joint of the first quadrant Q1 and the quadrant end joint AQ1 of the first quadrant, and a system 80 of pulleys and belts or cables linking the second joint of said first quadrant Q1, the third joint of said first quadrant and the quadrant end joint AQ1 of the first quadrant.

Thus, in this second exemplary embodiment, a motor is removed at one of the three joints, the latter is then constrained relative to the other two joints. In other words, when the two motor-driven joints perform their rotational movements, the non-motor-driven joint performs the movement that will be imposed thereon by the constraint that has been mechanically imposed thereon by the belts. The imposed load consists in keeping the torso T1 of the first quadrant Q1 and the torso T2 of the second quadrant Q2 parallel to one another. By “keeping the torso of the first quadrant and the torso of the second quadrant parallel to one another”, it should be understood keeping the first axis Z11 of the first quadrant Q1 parallel to the first axis Z12 of the second quadrant.

Advantageously, such an arrangement may be applied for each quadrant. In general, the imposed constraint consists in keeping the torso T of one quadrant Q and the torso of the next quadrant parallel to one another.

Thus, in the example of FIG. 6, where the robotic system includes four quadrants, and four limbs per quadrant, the robotic system includes sixteen joints and therefore twelve motors.

Like for the first embodiment of the actuating means, the actuation of the joints may be obtained by any suitable type of motor.

Preferably, the motor is either arranged at the associated joint or is offset therefrom.

Moreover, like for the first embodiment of the actuating means, each motor is preferably provided with a measuring device.

In a first variant of this second exemplary embodiment, the system 80 of pulleys and belts or cables is installed on a quadrant of the robotic system 100 by a so-called parallel mounting. Advantageously, a parallel mounting allows easily installing the system 80 of pulleys and belts or cables on the quadrant of the robotic system, or removing it, without having to dismount the quadrant of the robotic system. The system of pulleys and belts or cables is in a kinematic chain parallel to the kinematic chain of the robotic system.

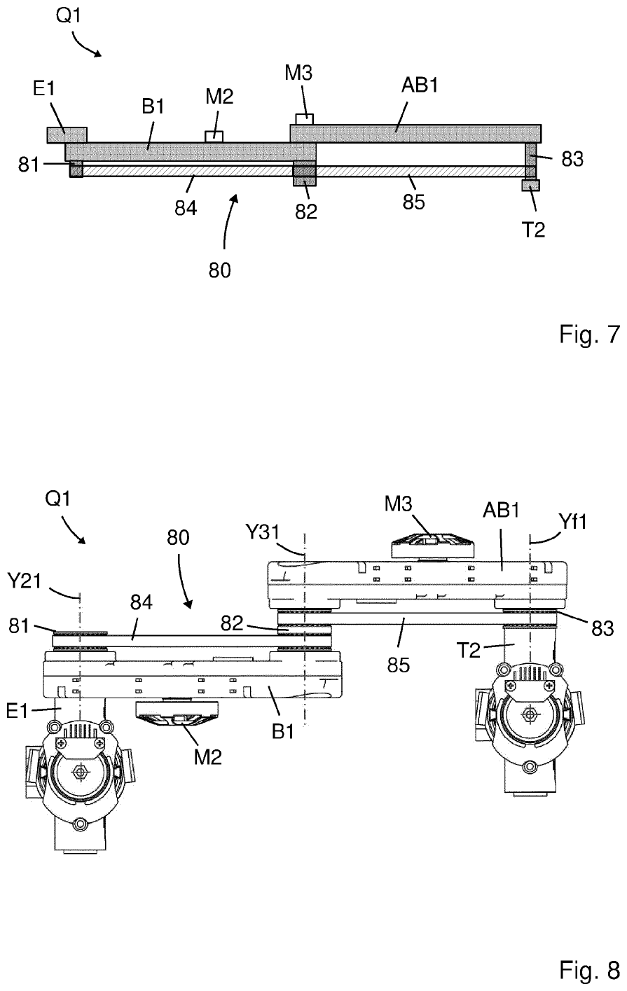

An example of this first variant is now described for the first quadrant, as illustrated in FIG. 7. In this embodiment, the motors linked to the second joint and the third joint of the first quadrant are kept, and the motor linked to the quadrant end joint of the first quadrant is removed. The quadrant end joint AQ1 of the first quadrant Q1 will be constrained relative to the second joint and the third joint of the first quadrant Q1.

The second joint of the first quadrant Q1, linking the shoulder E1 and the arm B1, is made by a pivot connection. The second motor M2 sets the angle between the shoulder E1 and the arm B1 and is preferably arranged at the arm B1, for example substantially at mid-length.

Similarly, the third joint of the first quadrant Q1, linking the arm B1 and the forearm AB1, is made by a pivot connection. The third motor M3 sets the angle between the arm B1 and the forearm AB1 and is preferably arranged at the third joint.

A first pulley 81 is fixedly secured to the shoulder E1 of the first quadrant Q1, at the second joint.

A central pulley 82 is arranged at the third joint of the first quadrant Q1. The central pulley 82 is fixedly linked neither to the arm B1 nor to the forearm AB1 of the first quadrant. The central pulley 82 is on a pivot connection distinct from the third joint, but shares the same axis as the third joint of the first quadrant.

A second pulley 83 is fixedly secured to the torso T2 of the second quadrant Q2, at the quadrant end joint AQ1 of the first quadrant Q1.

A first belt 84, or cable, links the first pulley 81 to the central pulley 82. A second belt 85, or cable, links the central pulley 82 to the second pulley 83.

Thus, when the second motor M2 modifies the angle between the shoulder E1 and the arm B1 of the first quadrant Q1, the first belt 84 will drive the central pulley 82, and the latter will drive the second belt 85, which will constrain the angle between the forearm AB1 of the first quadrant Q1 and the torso T2 of the second quadrant Q2 such that the first axes Z11, Z12 of the first and second quadrants remain parallel to one another.

By analogy, it is also possible to keep the motors linked to the third joint of the first quadrant and the quadrant end joint of the first quadrant, remove the motor of the second joint of the first quadrant and constrain the latter to the third joint of the first quadrant and to the quadrant end joint of the first quadrant.

In a second variant of the second exemplary embodiment, the system 80 of pulleys and belts or cables is nested in the robotic system. The system 80 of pulleys and belts or cables is in the kinematic chain of the robotic system 100. Consequently, the installation of the system of pulleys and belts or cables on the robotic system, or the removal thereof, requires dismounting the robotic system.

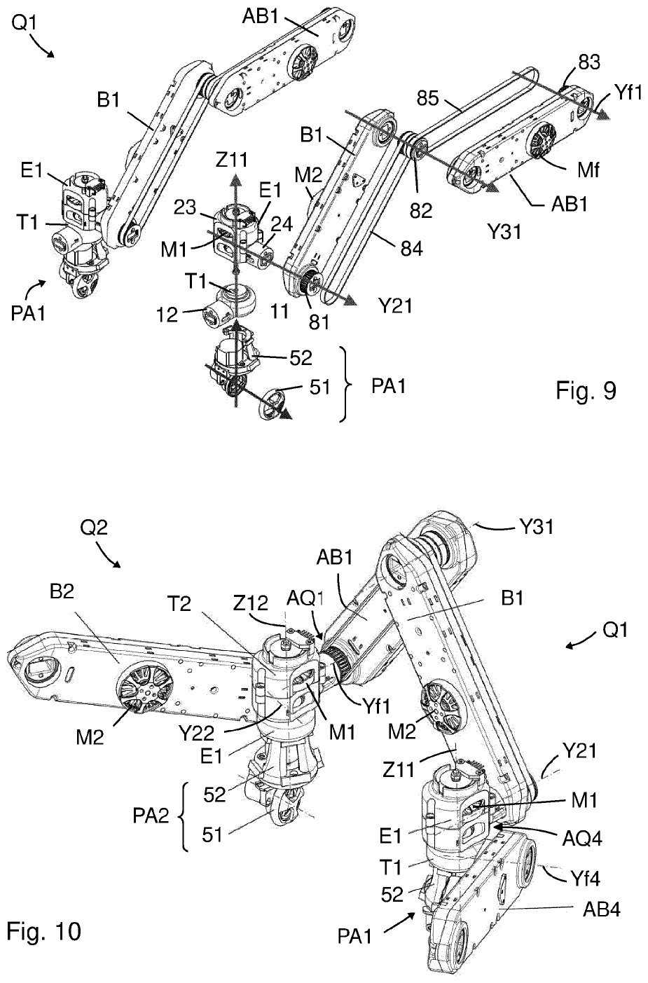

An example of this second variant is now described for the first quadrant, as illustrated in FIGS. 8 and 9. In this example, the third joint is composed of a first pivot connection linking the arm B1 to a part also called central pulley 82 and a second pivot connection with the same axis as the first pivot connection and linking the central pulley 82 to the forearm AB1. In other words, the third joint, linking the arm B1 and the forearm AB1, is made from a combination of two pivot connections with the same axis. Each of these pivot connections is motor-driven. Hence, the third joint includes two motors.

The second joint of the first quadrant Q1, linking the shoulder E1 and the arm B1, is made by a pivot connection.

A first pulley 81 is fixedly secured to the shoulder E1 of the first quadrant, at said second joint.

A second pulley 83 is fixedly secured to the torso T2 of the second quadrant Q2, at the quadrant end joint AQ1 of the first quadrant Q1.

A first belt 84, or cable, links the first pulley 81 to the central pulley 82. A second belt 85, or cable, links the central pulley 82 to the second pulley 83.

The second motor M2 sets the angle between the arm B1 and the central pulley 82 by acting on the first pivot connection of the third joint. Preferably, the second motor M2 is arranged at the arm B1, for example substantially at mid-length. It may also be arranged directly in the axis of the second pivot connection of the third joint, in direct transmission. The third motor M3 sets the angle between the central pulley 82 and the arm B1 by acting on the second pivot connection of the third joint. Preferably, the third motor M3 is arranged at the forearm AB1, for example substantially at mid-length. It may also be arranged directly in the axis of the second pivot connection of the third joint, in direct transmission.

In comparison with the first variant, the main modification lies in the positioning of the central pulley 82. Rather than positioning a motor that sets the angle between the shoulder E1 and the arm B1 of the first quadrant Q1 and a motor that sets the angle between the arm B1 and the forearm B1 of the first quadrant, a motor which drives the angle between the arm and the central pulley and a motor which drives the angle between the central pulley and the forearm of the first quadrant are positioned. In this second variant, the second and third motors M2 and M3 may be fastened in the axis of the third joint. Advantageously, such an arrangement allows lightening the second joint and the quadrant end joint of the first quadrant Q1.

In addition, in this second variant, the pulley system may be decomposed into two assemblies: a first assembly at the arm and a second assembly at the forearm. By separating the central pulley into two parts that fixedly interlock, it is then possible to easily disassemble the arm from the forearm.

In one embodiment (not shown), when the robotic system 100 includes a locking/unlocking device configured to detach two successive quadrants, also called upstream quadrant and the downstream quadrant, and when a quadrant end joint AQ of the upstream quadrant includes a pre-torso, said two successive quadrants are configured so as to be able to be reversibly detached, at the connection with no degrees of freedom linking the pre-torso of the upstream quadrant to the torso of the downstream quadrant.

In one example, the first fastening element of the locking/unlocking device is fixedly linked to the pre-torso of the upstream quadrant and the second fastening element of the locking/unlocking device is fixedly linked to the torso of the downstream quadrant.

In one embodiment (not shown), when the robotic system 100 includes, on at least one quadrant, a connector configured to receive a tool, said connector is preferably arranged on the forearm of said at least one quadrant, for example at its second end 22.

### Shapes of the Limbs of a Quadrant

In a preferred embodiment, the bodies forming the arm B and the forearm AB of a quadrant Q are formed by two shells assembled in a reversible manner, delimiting a hollow inner space. Advantageously, this hollow inner space allows in particular the storage of the batteries for powering the motors, the passage of the power supply cables of the motors, or the storage of tools.

FIGS. 9 and 10 illustrate a first non-limiting exemplary embodiment of the shape of the torso and shoulder of a quadrant. FIG. 9 shows an assembled view and an exploded view of the first quadrant. The example of FIG. 10 is illustrated for the first quadrant Q1 of the robotic system, but may apply to any quadrant.

The torso T1 of the first quadrant is in the form of a generally cylindrical body 11, with the first axis Z11 as its longitudinal axis. The torso T1 further includes means for forming a pivot connection with the forearm AB4 of the fourth quadrant, of axis Yf4. Advantageously, said means of the torso T1 include a cylindrical pin 12 extending radially from the body 11, and intended to be inserted into a complementary cylindrical housing made across the thickness of the forearm AB4 of the fourth quadrant Q4, at the second end 42 of said forearm.

The shoulder E1 of the first quadrant Q1 is in the form of a body 23, generally cylindrical, with the first axis Z11 as its longitudinal axis. The shoulder E1 further includes means for forming a pivot connection with the arm B1 of the first quadrant, of axis Y21. Advantageously, said means of the shoulder E1 comprise a cylindrical pin 24 extending radially from the body 23, and intended to be inserted into a complementary cylindrical housing made across the thickness of the arm B1, at the first end 31 of said arm.

The shoulder E1 is positioned above the torso T1, with their respective longitudinal axes being coaxial. In a non-limiting example, the torso T1 fits into the inner ring of a ball bearing and the shoulder E1 fits around the outer ring of the ball bearing. The two limbs and the bearing at the middle are crossed by a metal axis centered on the axis of the ball bearing at the middle. Preferably, the metal axis is held by a second ball bearing in the torso T1 and another ball bearing in the shoulder E1 to reinforce the connection.

Preferably, the body 23 of the shoulder E1 is hollow, as illustrated in FIG. 9, such that it can receive the first motor M1 intended to manage the first joint of the first quadrant Q1.

In one variant, the shoulder E1 is positioned below the torso T1, with their respective longitudinal axes being coaxial. The body 11 of the torso T1 is hollow such that it can receive the first motor intended to manage the first joint of the first quadrant Q1.

As an illustration of this first example, and of its variant, FIG. 10 shows the first and second quadrants Q1, Q2 assembled by the quadrant end joint AQ1 of the first quadrant and the forearm AB4 of the fourth quadrant assembled to the first quadrant Q1 by the quadrant end joint AQ4 of the fourth quadrant Q4. The torso T1 of the first quadrant Q1 has a shape similar to the shoulder E2 of the second quadrant Q2 and the shoulder E1 of the first quadrant Q1 has a shape similar to the torso T2 of the second quadrant Q2. Thus:
For the first quadrant Q1:
   the shoulder E1 is arranged above the torso T1;
   the body 23 of the shoulder E1 receives the first motor M1 intended to manage the first joint of the first quadrant Q1;
   the bearing part PA1 is linked to the lowest part of the torso-shoulder assembly, herein the torso T1;
For the second quadrant Q2:
   the torso T2 is arranged above the shoulder E2,
   the body 11 of the torso T2 receives the first motor M1 intended to manage the first joint of the second quadrant Q2;
   the bearing part PA2 is linked to the lowest part of the torso-shoulder assembly, herein the shoulder E2.

The arm B1 and the forearm AB1 of the first quadrant Q1 having the same length, such an arrangement advantageously allows keeping the first end 31 of the arm B1 and the second end 42 of the forearm AB1 of the first quadrant Q1 substantially at the same height with respect to the ground, when the ground is flat and the bearing parts PA1, PA2 of the first and second quadrants Q1, Q2 are substantially similar. Such an arrangement allows avoiding the robotic system 100 tilting over.

Such an arrangement is preferable when the robotic system 100 includes an even number of quadrants.

Thus, in the example of a robotic system 100 with four quadrants, the first and third quadrants Q1, Q3 have similar torsos T1, T3 and shoulders E1, E3, and the second and fourth quadrants Q2, Q4 have similar torsos T2, T4 and shoulders E2, E4.

In general, the arm, respectively the forearm, of a quadrant is respectively linked to the contiguous limb (shoulder, respectively torso) on the upper part of the associated torso-shoulder assembly.

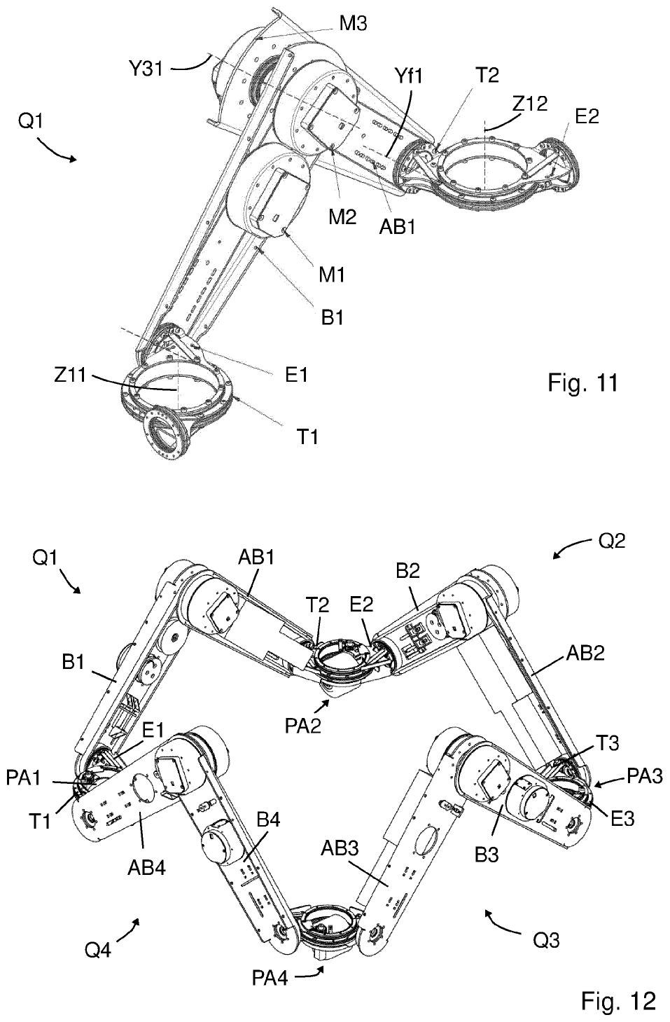

FIG. 11 illustrates a second non-limiting exemplary embodiment of the shape of the torso and shoulder of a quadrant. The example of FIG. 1 is illustrated for the first quadrant Q1 of the robotic system 100, but may apply to any quadrant. FIG. 11 illustrates the torso T1—shoulder E1 assembly of the first quadrant Q1 and the torso T2—shoulder E2 assembly of the second quadrant. Only the torso T1—shoulder E1 assembly of the first quadrant Q1 is described.

The torso T1—shoulder E1 assembly of said first quadrant includes two annular parts, or hoops, preferably with a circular shape. An internal annular part forms the shoulder E1 and an external annular part forms the torso T1. The shoulder E1 and the torso T1 are arranged orthogonally to the first axis Z1, the center of said shoulder and of said torso being located on the first axis Z11. The pivot connection enabling the rotation according to the first axis Z11 between the shoulder E1 and the torso T1 is achieved by means of ball bearings.

Such a shape of the shoulder E1 and of the torso T1 enables the positioning of a bearing part (not shown in the figure), such as for example a ball, inside the shoulder E1 and the torso T1 and advantageously reduce the bulk of the robotic system 100. The bearing part is linked either to the shoulder, or to the torso.

The torso T, shoulder E, arm B, forearm AB limbs of a quadrant Q may have other shapes different from those described without departing from the scope of the invention.

The above-described shapes of the limbs are non-exhaustive and other shapes may be made, insofar as they enable the necessary rotations between two successive limbs.

### Shape of a Bearing Part

As described before, the robotic system 100 further includes, at each quadrant, a bearing part PA intended to come into contact with a bearing surface.

Preferably, the bearing part PA is connected either to the torso T or to the shoulder E of a quadrant.

In the example of FIGS. 9 and 10, the bearing part PA1 of the first quadrant Q1 is linked to the torso T1. The bearing part PA2 of the second quadrant Q2 is linked to the shoulder E2.

In an improved exemplary embodiment of the bearing part, as illustrated in FIGS. 9 and 10, the bearing part PA1, PA2 of the first quadrant or of the second quadrant includes, besides a wheel 51, an additional part, also called pelvis 52, arranged between the wheel 51 and the torso or the shoulder. The pelvis 52 and the wheel 51 form a wheel module.

The pelvis 52 of the wheel module associated with the first quadrant Q1 is positioned under the torso T1, with their respective longitudinal axes being coaxial, and linked to said torso T1 by a pivot connection enabling a rotation about the first axis Z11, allowing orienting the wheel. The wheel 51 is linked to the pelvis 52 by a pivot connection enabling the rotation of the wheel according to the axis of the wheel, said axis of the wheel being orthogonal to the first axis Z11.

In other exemplary embodiments of the bearing part, not shown, the bearing part may be a Mecanum-type wheel, a foot with a shock absorber or a wheel with a shock absorber.

### Another Exemplary Embodiment of the Robotic System According to the Third Configuration:

FIGS. 12 to 27 illustrate a preferred exemplary embodiment of a robotic system according to the third configuration.

The specificities described for the third configuration hereinabove are replicated.

In this exemplary embodiment, all of the joints enable only a rotation about an axis. The joints are of the pivot connection type, enabling only one degree of freedom in rotation, in combination with fixed connections or not.

FIG. 12 illustrates a robotic system including four quadrants Q1, Q2, Q3, Q4 each including four limbs, without limitation. Each quadrant Q1, Q2, Q3, Q4 is equipped with a bearing part PA1, PA2, PA3, PA4 of the wheel or foot type. A connector (not visible in FIG. 12) allowing detaching the fourth quadrant Q4 from the first quadrant Q1 is positioned between the forearm AB4 of the fourth quadrant Q4 and the torso T1 of the first quadrant Q1. FIG. 13 illustrates one of the quadrants of the robotic system of FIG. 12, as a non-limiting example, the first quadrant Q1. FIG. 14 shows an exploded view of the quadrant of FIG. 13. As illustrated in FIGS. 13 and 14, the torso T1 is equipped with a foot 54.

The central pulley 82 is highlighted in FIG. 14. In this exemplary embodiment, the central pulley 82 belongs to the third joint of the first quadrant Q1 linking the arm B1 by a first pivot connection and the forearm AB1 by a second pivot connection. The central pulley 82 is rigidly linked to a first part 821, itself fastened on the rotor of the second motor M2. The stator of the second motor M2 is linked to the arm B1. Hence, said first pivot connection is formed by the second motor M2 and its internal pivot connection between its stator and its rotor. The central pulley 82 is rigidly linked to a second part 822, itself fastened on the rotor of the third motor M3. The stator of the third motor M3 is linked to the forearm AB1. Hence, said second pivot connection is formed by the third motor M3 and its internal pivot connection between its stator and its rotor. Advantageously, the internal rotation axes of the second and third motors M2, M3 are collinear with the third axis Y31. Thus, the third joint is formed by the second and third motors M2, M3 and the central pulley 82.

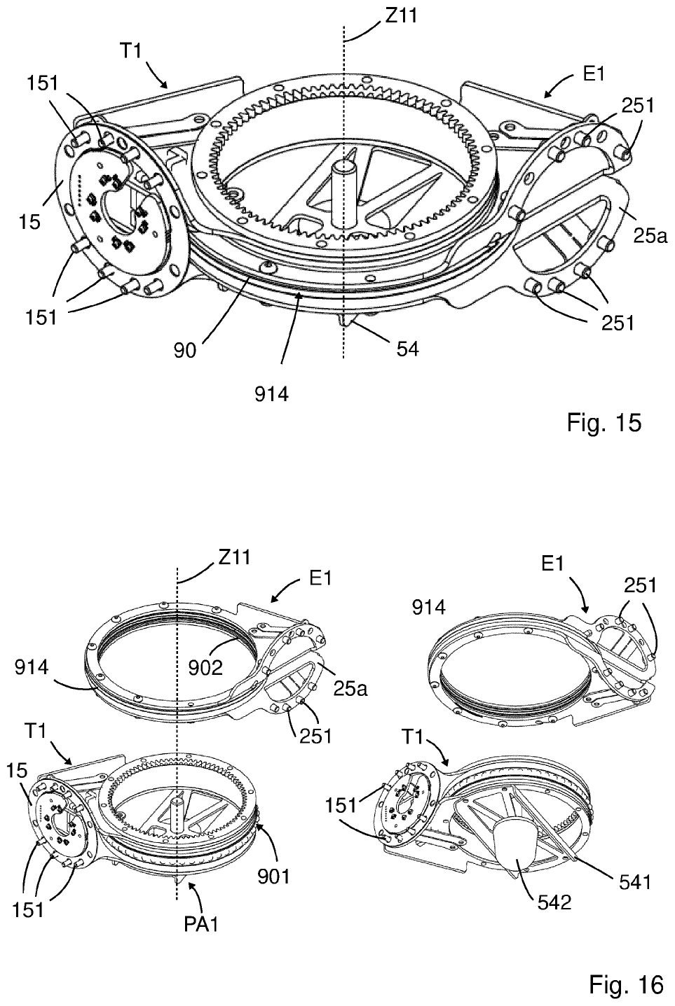

FIG. 15 illustrates an enlarged view of the torso T1—shoulder E1 assembly, equipped with the foot 54, of the first quadrant of FIG. 13. FIG. 16 shows two exploded views of the assembly of FIG. 15, a first exploded view, seen in perspective top view and a second exploded view, seen in perspective bottom view. The shoulder E1 includes, at one end 25a, screws 251 for fastening thereof to the second joint linking it to the arm B1.

The torso T1 includes, at one end 15, screws 151 for fastening thereof to the quadrant end joint of the preceding quadrant, linking it to the last limb of the preceding quadrant. In the example, the screws 151 of the torso T1 allow fastening it to the quadrant end joint of the fourth quadrant Q4 linking it to the forearm AB4 of said fourth quadrant.

Advantageously, the end 25a of the shoulder E1 is fastened on a ball bearing (not shown) forming the second joint with the arm B1.

Advantageously, the end 15 of the torso T1 is fastened on a ball bearing (not shown) composing the quadrant end joint of the preceding quadrant with the forearm of said fourth quadrant.

The shoulder E1 is assembled on the torso T1 by means of a ball bearing 90. The ball bearing includes an inner ring 901, whose balls can be distinguished in FIG. 16, and an outer ring 902. Said ball bearing 90 forms the first joint of the first quadrant Q1. Thus, the first joint forms a pivot connection, enabling only a rotation about the first axis Z11.

The exploded view, seen in perspective bottom view, of FIG. 16 illustrates an exemplary embodiment of a foot 54 and its assembly on the torso T1. The foot 54 includes a fastening part 541 and a pad P12, for example made of rubber. The pad 542 serves as a contact surface with a bearing surface. Advantageously, the fastening part 541 allows linking the pad 542 to the torso T1 throughout a fixed connection.

In the example of FIGS. 15 and 16, the motor drive of the first joint is offset, the first motor M1 (not shown) being located on a contiguous part (not shown) to lighten the torso T1 and the shoulder E1, and the power is transmitted by a cable system (not shown in the figures). Grooves 914 in which the cables run while winding around the shoulder E1 are shown in FIG. 16.

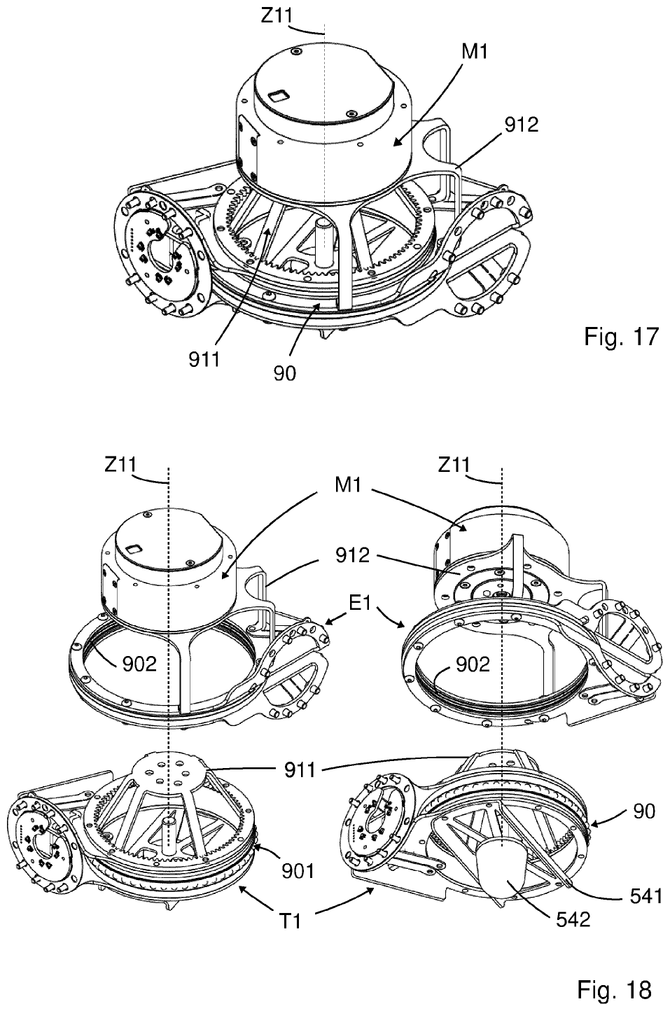

FIGS. 17 and 18 show the same torso T1—shoulder E1 assembly as that of FIGS. 15 and 16, but with a different motor drive for the first joint. In FIGS. 17 and 18, the first motor M1, that driving the first joint, is located on the first joint, with an axis of rotation collinear with the first axis Z11. A first part 911 is fastened to the stator of the first motor M1 and to the shoulder E1. A second part 912 is fastened to the rotor of the first motor M1 and to the torso T1. All of the elements: first motor M1, first part 911, second part 912, ball bearing 90, inner ring 901, outer ring 902 of said ball bearing 90 compose and drive the first joint according to the first axis Z11.

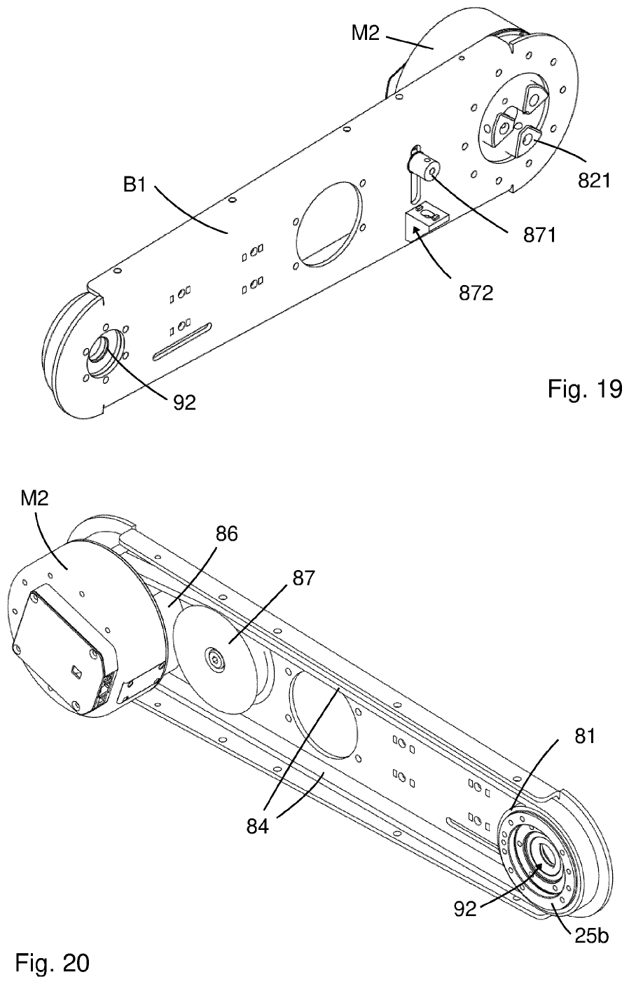

FIGS. 19 and 20 illustrate the arm B1 of the first quadrant of FIG. 13. In these figures, there is shown an element 25b, complementary to the end 25a (illustrated in FIG. 16) of the shoulder E1, arranged on a ball bearing 92 composing the second joint with the arm B1. The second motor M2 is also identified, whose stator is fastened to the arm B1 and the rotor is fastened to the first part 821, to compose, with the central pulley 82, the third joint of the first quadrant. The motor-driven system described herein does not include a motor on the second joint. Actuation of the second joint of the first quadrant Q1 is ensured by a system of pulleys and belts or cables which forms a constraint system. Said second joint is linked to the first belt 84 with the first pulley 81. The third joint of the first quadrant is linked to the first belt 84 by a third pulley 86. The first pulley 81 and the third pulley 86 are embedded on an outer ring of the ball bearings forming the second and third joints. The second motor M2 is shared by the second and third joints. Advantageously, a tensioner 87 allows setting the tension of the first belt 84. FIG. 19 illustrates a fastening point 871 of the tensioner 87 on the arm B1. Advantageously, a screw 872 allows setting the height of the fastening point 871 of the tensioner 87 to the arm B1. Thus, by acting on the screw 872, one could act directly on the height of the fastening point 871 and therefore of the tensioner 87, which allows setting the tension of the first belt 84.

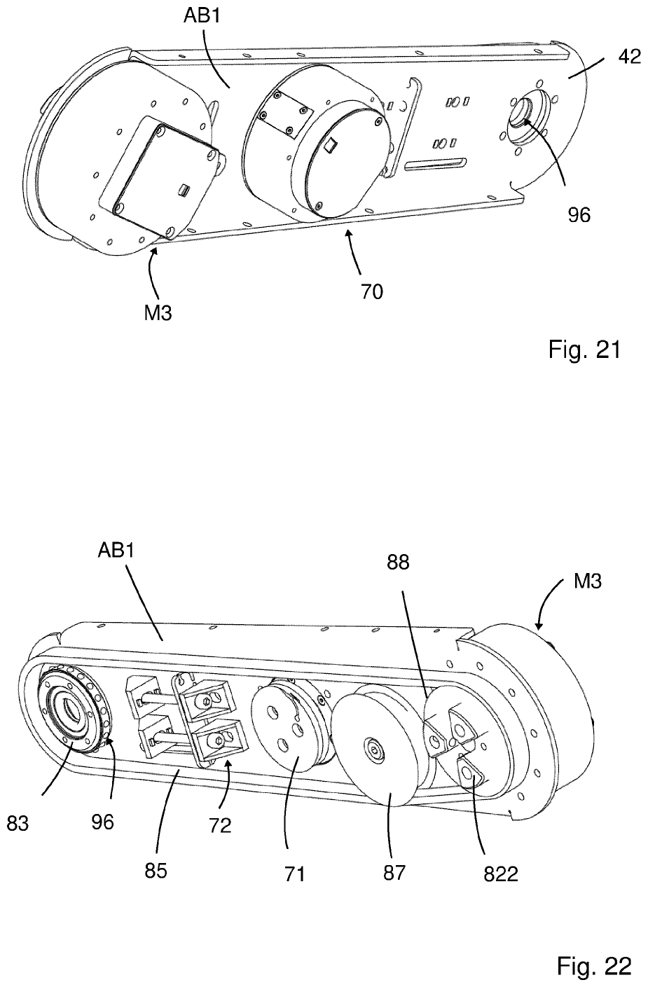

FIGS. 21 and 22 illustrate the forearm AB1 of the first quadrant of FIG. 13. The forearm AB1 has a behavior similar to the arm B1. In particular, the third motor M3 and the second part 822, linked to the central pulley 82, homologous to the second motor M2 and the first part 821, linked to the central pulley 82, of the arm B1, are illustrated. Similarly, a system of pulleys and belts for the forearm AB1 including the second pulley 83, a fourth pulley 88, the second belt 85 and a tensioner 87, equivalent to the first pulley 81, the third pulley 86, the first belt 84 and the tensioner 87 forming the system of pulleys and belts of the arm B1. One could also imagine a ball bearing 96 composing the quadrant end joint AQ1 of the first quadrant Q1. An inner ring of said ball bearing 96 is fastened at the forearm AB1 and an outer ring of said ball bearing 96 is intended to be fastened to the torso T2 of the second quadrant Q2.

In these FIGS. 21 and 22, there are also illustrated elements 70, 71 and 72 of the motor drive of the first joint of the second quadrant Q2, in the case where the motor drive of the first joint of said second quadrant is offset on the first quadrant Q1. The shoulder E2 of the second quadrant Q2 further includes grooves (not shown), identically to the grooves 914 of the shoulder E1 of the first quadrant. The elements 70, 71, 72 and said grooves of the shoulder E2 of the second quadrant compose the motor drive offset from the first joint of the second quadrant Q2. The element 70 is a motor. The element 71 is a pulley around which power transmission cables are wound. The element 72 is a sheath support. The cables extending from the pulley 71 are guided by sheaths supported by the sheath support 72. Said sheaths guide the cables up to the grooves of the shoulder E2 of the second quadrant around which they are wound. Thus, said cables are wound around the shoulder E2 and the pulley 71. When the pulley 71 is rotated by the motor 70, the power is transmitted to the shoulder E2 by said cables.

The motor 70, pulley 71, sheath support 72 assembly may be installed without modification on the arm B2 of the second quadrant Q2 instead of being installed on the forearm of the first quadrant.

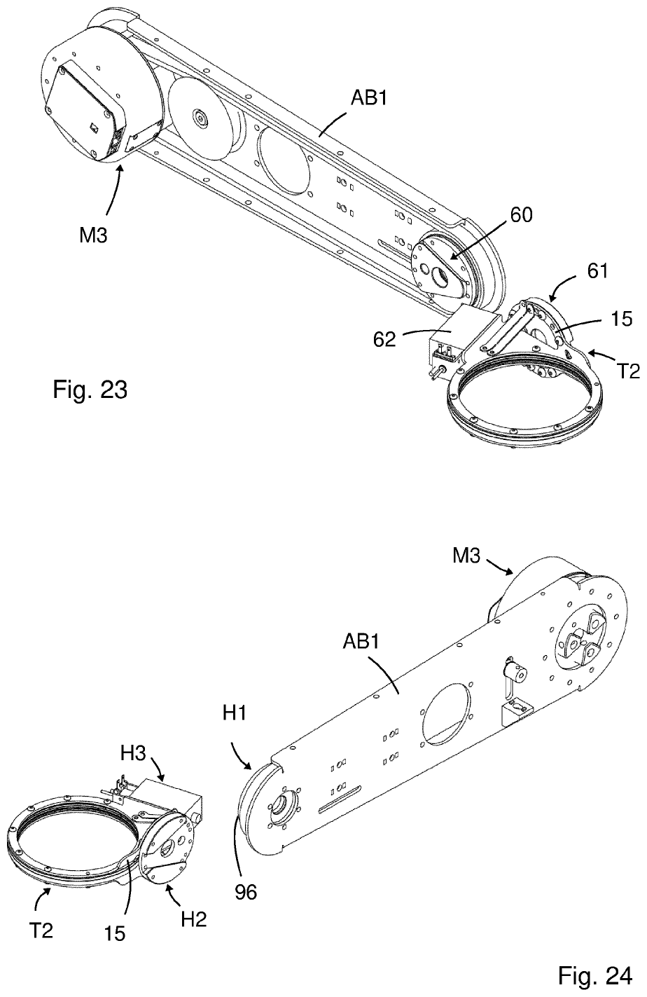

FIGS. 23 and 24 illustrate an example of a locking/unlocking system configured to reversibly detach the first quadrant from the second quadrant, at the quadrant end joint AQ1 of the first quadrant. The forearm AB1 of the first quadrant Q1 is linked to the torso T2 of the second quadrant Q2 by said quadrant end joint AQ1 of the first quadrant Q1. In this case, said quadrant end joint AQ1 of the first quadrant Q1 is composed of a first pivot connection composed of a ball bearing 96. An inner ring of the bearing 96 is fastened to the forearm AB1 of the first quadrant. Like for the above-described forearm, this pivot connection is actuated by a system of belts and cables linking it to the third joint and to the third motor M3. The quadrant end joint AQ1 of the first quadrant Q1 is also composed of a fixed connection between the pre-torso and the torso T2 of the second quadrant. This fixed connection may be locked and unlocked. Preferably, the pre-torso is rigidly fastened to an outer ring of the ball bearing 96, therefore after the pivot connection formed by the ball bearing 96. Preferably, the fixed connection is made by two elements 60 and 61. The element 60 of the fixed connection is fastened on the pre-torso and the element 61 is fastened on the torso T2, at one end 15 of said torso T2 of the second quadrant. The elements 60 and 61 of the fixed connection mechanically interlock. When the elements 60 and 61 of the fixed connection are completely interlocked, an electromagnet 62 activates a lock intended to lock the fixed connection. By deactivating the lock, it is then possible to detach said fixed connection and separate the forearm AB1 of the first quadrant Q1 from the torso T2 of the second quadrant Q2.

It is clear that the locking/unlocking system described in FIGS. 23 and 24 could be adapted to any other quadrant configuration, with a different number of limbs and operation. The locking/unlocking system may be positioned on all of the joints of the robotic system.

Advantageously, the locking/unlocking system described in FIGS. 23 and 24 may be adapted to a tool connector to equip the robotic system with removable tool. For example, such a connector may be positioned on the forearm AB1 of the first quadrant. Referring to FIG. 21, the element 61 of the fixed connection and the electromagnet 62 could be positioned at the second end 42 of the forearm AB1 of the first quadrant and the element 60 of the fixed connection, at the tool to be connected.

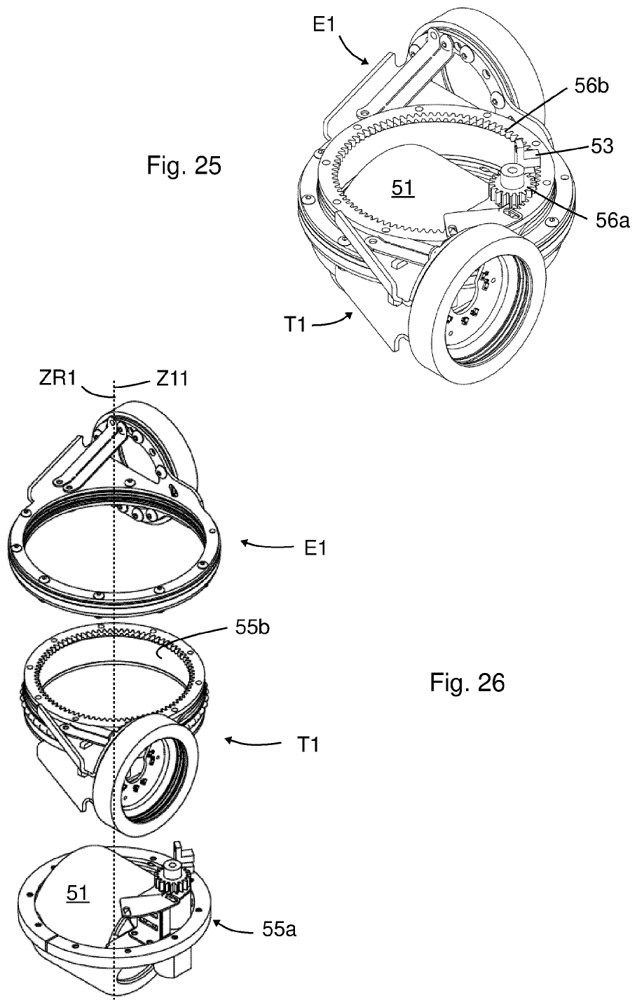

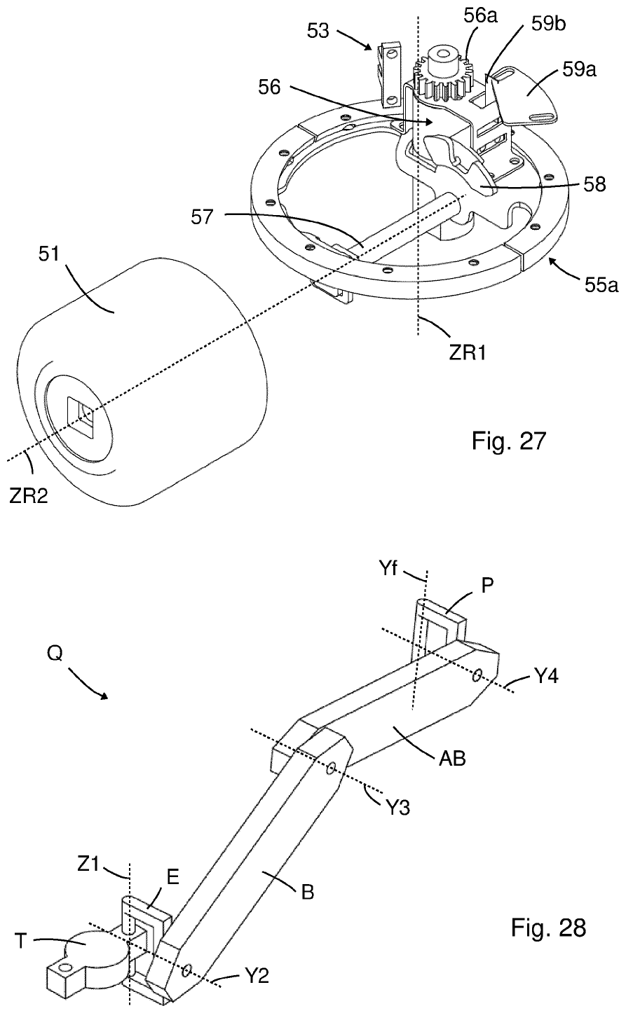

FIGS. 25 to 27 illustrate a torso-shoulder assembly identical to those shown in FIGS. 15 to 18, but equipped with a wheel assembly instead of a foot. The first joint between the torso T1 and the shoulder E1 is herein made by the cable system described in FIGS. 15 and 16 but could perfectly be made with the direct transmission system described in FIGS. 17 and 18. The wheel assembly is fastened to the torso T1 by a first pivot connection with an axis ZR1. Preferably, the axis ZR1 is collinear with the first axis Z11 of the first joint between the torso T1 and the shoulder E1 of the first quadrant Q1. In one variant, the axis ZR1 is not collinear with the first axis Z1. For example, this first pivot connection with an axis ZR1 of the wheel assembly may be made with a plain bearing 55a inserted into a groove 55b of the torso T1 (cf. FIG. 26). The plain bearing 55a fills a function similar to that of a ball bearing, but at a lower cost. The motor drive of this first pivot connection with an axis ZR1 is ensured by a motor 56 which actuates a gear 56a configured to set the wheel in rotation about the axis ZR1 by interaction with a circular slide 56b. FIG. 27 illustrates an optical fork 53 configured to capture the movements of said pivot connection. The wheel assembly includes a second pivot connection with an axis ZR2 and which allows setting a wheel 51 in rotation. This second pivot connection of the wheel assembly is driven by a motor (not shown) located in the wheel 51. Thus, the wheel 51 rotates about an axis 57 (visible in FIG. 27). FIG. 27 also illustrates a structural element 58 acting as a brake on the wheel 51. In the non-limiting example of FIGS. 25 to 27, the brake 58 is pressed on the wheel 51 by the rotation of the wheel assembly relative to the torso T1 thanks to the adapted shape of a part 59a rigidly linked to the torso T1. When the orientation of the wheel assembly is suitable, a tab 59b slips on the part 59a and thereby advances the structural element 58 into engagement with the wheel. This advantageously allows dispensing with the use of an actuator specific to the brake.

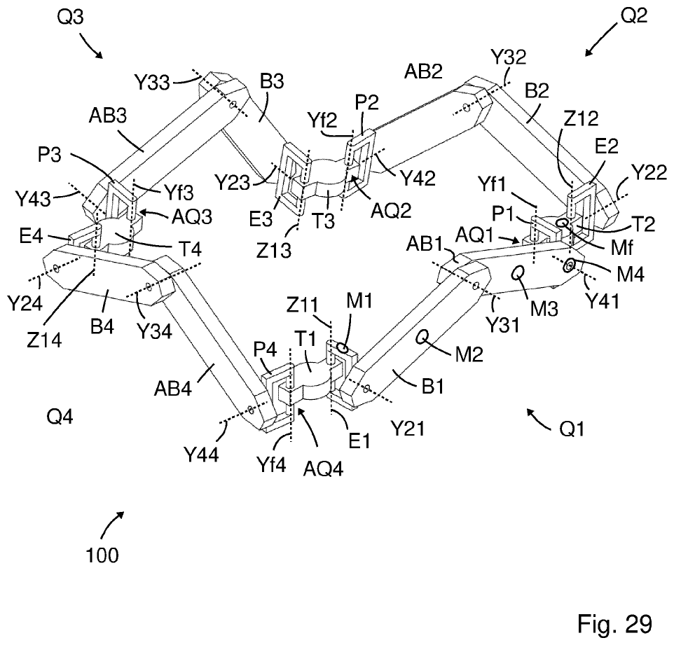

D—Robotic system including at least one quadrant with five limbs (FIGS. 28 and 29)

In a fourth configuration, as illustrated in FIG. 28, a quadrant Q of the robotic system 100 includes five successive limbs.

In the non-limiting example of FIG. 28, the robotic system 100 includes four quadrants Q1, Q2, Q3, Q4, each including four limbs. Although the quadrants are illustrated in FIG. 28 and described in the number of four, the number of these quadrants is not limited to that described and illustrated. Thus, it is possible to make a robotic system with three quadrants, five quadrants or more, without departing from the scope of the invention.

This fourth configuration replicates all of the elements (limbs, joints) described in the second configuration.

Thus, in general, and as schematically illustrated in FIG. 28, a quadrant Q according to the fourth configuration successively includes, besides the torso T, the shoulder E, the arm B, and the forearm AB, a fifth limb, also called wrist P.

Thus, in this fourth configuration, the forearm AB forms the last limb of the quadrant Q.

Like for the preceding three configurations:
the shoulder E is linked to the torso T by the first joint,
the arm B is linked to the shoulder E by the second joint,
the forearm AB is linked to the arm B by the third joint.

The first joint enables at least one rotation with a first axis Z1.

Preferably, and as illustrated in FIG. 28, the first joint enables only a rotation about the first axis Z1.

The second joint enables at least one rotation about a second axis Y2. Preferably, the second axis Y2 is orthogonal to the first axis Z1.

Preferably, and as illustrated in FIG. 28, the second joint enables only a rotation about the second axis Y2.

The third joint enables at least one rotation about a third axis Y3. Preferably, the third axis Y3 is parallel to the second axis Y2.

Preferably, and as illustrated in FIG. 28, the third joint enables only a rotation about the third axis Y3.

The wrist P is linked to the forearm AB by a joint, also called fourth joint.

Said fourth joint enables at least one rotation about a fourth axis Y4. Preferably, the fourth axis Y4 is parallel to the second axis Y2 and to the third axis Y3.

Preferably, and as illustrated in FIG. 28, the fourth joint enables only a rotation about the fourth axis Y4.

Preferably, each of the first, second, third and fourth joints of the quadrant Q is made by a pivot connection, for example by means of a plain bearing or ball bearings. It is also possible to make the third joint of the quadrant from a combination of two pivot connections with the same axis.

The torso T, the shoulder E, the arm B, the forearm AB and the wrist of a quadrant Q may have various shapes, insofar as these shapes do not limit the movement of the shoulder E relative to the torso T, obtained via the first joint, or the movement of the arm relative to the shoulder E, obtained via the second joint, the movement of the forearm AB relative to the arm B, obtained via the third joint, or the movement of the wrist P relative to the forearm AB, obtained via the fourth joint.

In a preferred embodiment, the shapes of the torso T, of the shoulder E, of the arm B and of the forearm AB, and of their different variants, described for the quadrant third configuration may apply to the torso T, to the shoulder E, the arm B and the forearm AB of the fourth configuration of the quadrant.

In a preferred exemplary embodiment, the shape of the wrist is substantially similar to that of the shoulder.

The quadrant end joint AQ of the quadrant Q links the wrist P of said quadrant to the torso of the next quadrant.

Said quadrant end joint AQ enables at least one rotation about an axis of rotation Yf. Said axis of rotation is parallel to the first axis of the first joint of the quadrant.

Preferably, as illustrated in FIGS. 28 and 29, the quadrant end joint AQ of the quadrant Q enables only a rotation about the axis of rotation Yf. Besides the fact that it should not limit the rotation about the first axis Z1 of the torso T relative to the shoulder E, by the first joint, the shape of the torso T of the quadrant should not also limit the rotation about the axis of rotation Yf of the wrist of the preceding quadrant relative to said torso of the quadrant, by the quadrant end joint of the quadrant.

In one embodiment of a quadrant end joint AQ, said quadrant end joint AQ is made by a pivot connection between the wrist of the quadrant and the torso of the next quadrant, for example by means of a plain bearing or ball bearings.

In another embodiment of a quadrant end joint AQ, said quadrant end joint AQ is made from a combination of a pivot connection and a connection with no degrees of freedom.

In a preferred exemplary embodiment, not shown, the quadrant end joint of a quadrant includes an auxiliary part, also called pre-torso, linked on the one hand to the wrist of the quadrant by a pivot connection enabling a rotation about the axis of rotation Yf and, on the other hand, to the torso of the next quadrant by a connection with no degrees of freedom.

In one embodiment, when a quadrant Q includes a bearing part PA, said bearing part PA is preferably linked either to the torso T or to the shoulder E of the quadrant.

In a preferred exemplary embodiment, the various shapes of the bearing part PA, foot, wheel, pelvis/wheel, described for the third configuration of a quadrant may also be adapted in this fourth configuration of a quadrant.

Returning now to the example of FIG. 29, where the robotic system 100 includes four quadrants, each quadrant is in the form described hereinabove.

Thus, by analogy, a first quadrant Q1 includes:
a torso T1,
a shoulder E1, linked to the torso T1 by a first joint enabling a rotation about a first axis Z11,
an arm B1, linked to the shoulder E1 by a second joint enabling a rotation about a second axis Y21,
a forearm AB1, linked to the arm B1 by a third joint enabling a rotation about a third axis Y31,
a wrist P1, linked to the forearm AB1 by a fourth joint enabling a rotation about a fourth axis Y41.

The axes Z11 and Y21 are orthogonal. The axes Y21, Y31 and Y41 are parallel.

A second quadrant Q2 includes:
a torso T2,
a shoulder E2, linked to the torso T2 by a first joint enabling a rotation about a first axis Z12,
the arm B2, linked to the shoulder E2 by a second joint enabling a rotation about a second axis Y22,
a forearm AB2, linked to the arm B2 by a third joint enabling a rotation about a third axis Y32,
a wrist P2, linked to the forearm AB2 by a fourth joint enabling a rotation about a fourth axis Y42.

The axes Z12 and Y22 are orthogonal. The axes Y22, Y32 and Y42 are parallel.

A third quadrant Q3 includes:
a torso T3,
a shoulder E3, linked to the torso T3 by a first joint enabling a rotation about a first axis Z13,
the arm B3, linked to the shoulder E3 by a second joint enabling a rotation about a second axis Y23,
a forearm AB3, linked to the arm B3 by a third joint enabling a rotation about a third axis Y33,
a wrist P3, linked to the forearm AB3 by a fourth joint enabling a rotation about a fourth axis Y43.

The axes Z13 and Y23 are orthogonal. The axes Y23, Y33 and Y43 are parallel.

A fourth quadrant Q4 includes:
a torso T4,
a shoulder E4, linked to the torso T4 by a first joint enabling a rotation about a first axis Z14,
the arm B4, linked to the shoulder E4 by a second joint enabling a rotation about a second axis Y24,
a forearm AB4, linked to the arm B4 by a third joint enabling a rotation about a third axis Y34,
a wrist P 4, linked to the forearm AB4 by a fourth joint enabling a rotation about a fourth axis Y 44.

The axes Z14 and Y24 are orthogonal. The axes Y24, Y34 and Y 44 are parallel.

The first quadrant Q1 (respectively second quadrant Q2, third quadrant Q3, fourth quadrant Q4) includes a quadrant end joint AQ1 (respectively AQ2, AQ3, AQ4) linking it to the second quadrant Q2 (respectively third quadrant Q3, fourth quadrant Q4, first quadrant Q1). Said first joint AQ1 (respectively AQ2, AQ3, AQ4) enables at least one rotation about an axis of rotation Yf1 (respectively Yf2, Yf3, Yf4), said axis of rotation Yf1 (respectively Yf2, Yf3, Yf4) being parallel to the first axis Z11 (respectively Z12, Z13, Z14), of the first joint of the first quadrant Q1 (respectively second quadrant Q2, third quadrant Q3, fourth quadrant Q4).

Preferably, the various actuating means described in the third configuration of a quadrant may be adapted to this quadrant fourth configuration.

Thus, in a first embodiment, each joint of the quadrants of the robotic system includes an associated motor. For example, for the first quadrant, as illustrated in FIG. 29:
a first motor M1 is intended to drive and move the shoulder E1 relative to the torso T1 about the first axis Z11,
a second motor M2 is intended to drive and move the arm B1 relative to the shoulder E1 about the second axis Y21,
a third motor M3 is intended to drive and move the forearm AB1 relative to the arm B1 about the third axis Y31,
a fourth motor M4 is intended to drive and move the wrist P1 relative to the forearm AB1 about the fourth axis Y41,
a last motor Mf is intended to drive and move the torso T2 of the next quadrant, namely the second quadrant Q2, relative to the wrist P1 of the first quadrant Q1 about the axis of rotation Yf1.

In a second embodiment (not shown), the actuating means include fewer motors than joints. For example, the actuating means include, for example for the first quadrant Q1:
a first motor M1 configured to drive the first joint of the first quadrant Q1, by moving the shoulder E1 relative to the torso T1 in rotation about the first axis Z11,
two motors M2, M3, configured to drive two joints selected from among the second joint, the third joint and the fourth joint of the first quadrant Q1, and a system of pulleys and belts or cables linking the second joint, the third joint and the fourth of the first quadrant Q1,
a last motor Mf configured to drive the quadrant end joint AQ1 of the first quadrant Q1, by moving the torso T2 of the next quadrant, namely the second quadrant Q2, relative to the wrist P1 of the first quadrant Q1 about the axis of rotation Yf1.

The variants of this second embodiment described in the third configuration of a quadrant may be adapted to this quadrant fourth configuration.

In one embodiment (not shown), like in the quadrant third configuration, when the robotic system 100 includes a locking/unlocking device configured to detach two successive quadrants, also called upstream quadrant and the downstream quadrant, and when a quadrant end joint AQ of the upstream quadrant includes a pre-torso, said two successive quadrants are configured so as to be able to be reversibly detached, at the connection with no degrees of freedom linking the pre-torso of the upstream quadrant to the torso of the downstream quadrant.

In one embodiment (not shown), like in the quadrant third configuration, when the robotic system 100 includes, on at least one quadrant, a connector configured to receive a tool, said connector is preferably arranged on the forearm of said at least one quadrant, for example at its second end 22.

1-21. (canceled)

22. A mobile robotic system, capable of moving, comprising N articulated structures connected to one another pairwise in series to form a loop, N being a positive integer greater than or equal to 3, each articulated structure also being referred to as a quadrant, each quadrant comprising:
at least two successive limbs, comprising a first limb referred to as a torso and a last limb, two successive limbs of the quadrant being connected to one another to enable at least one rotation;
a quadrant end joint linking the last limb of the quadrant to the torso of a next quadrant;
wherein at least one quadrant of the mobile robotic system comprises at least three successive limbs:
the torso;
a second limb, referred to as a shoulder, linked to the torso by a first joint, enabling a rotation about a first axis; and
a third limb, referred to as an arm, linked to said shoulder by a second joint, enabling a rotation about a second axis, the second axis being orthogonal to said first axis.

23. The robotic system of claim 22, further comprising no central body on which said each quadrant is linked.

24. The robotic system of claim 22, further comprising, at said each quadrant, an actuator configured to move all or part of the first joint, the second joint and the quadrant end joint.

25. The robotic system of claim 22, wherein said at least one quadrant further comprises a bearing part configured to come into contact with a bearing surface.

26. The robotic system of claim 22, further comprising at least one locking/unlocking device configured to reversibly detach two successive quadrants.

27. The robotic system of claim 22, further comprising, on said at least one quadrant, a connector linked to one of the limbs of said at least one quadrant, and the connector configured to receive at least one tool.

28. The robotic system of claim 22, wherein when said at least one quadrant includes only three successive limbs, the arm is the last limb and the quadrant end joint is a ball joint connection.

29. The robotic system of claim 22, wherein said at least one quadrant comprises four successive limbs:
the torso;
the shoulder linked to the torso by the first joint;
the arm linked to the shoulder by the second joint; and
a fourth limb, referred to as a forearm, linked to the arm by a third joint, the forearm being the last limb.

30. The robotic system of claim 29, wherein the third joint is configured to enable a rotation about a third axis, the third axis being parallel to the second axis.

31. The robotic system of claim 29, wherein the quadrant end joint of said at least one quadrant with four successive limbs is configured to enable a rotation about an axis of rotation.

32. The robotic system of claim 31, wherein the axis of rotation is parallel to the second axis and the third axis.

33. The robotic system of claim 30, further comprising, at said each quadrant, an actuator configured to move all or part of the first joint, the second joint and the quadrant end joint; and wherein the actuator comprises an associated motor for each joint forming the robotic system.

34. The robotic system of claim 30, further comprising, at said each quadrant, an actuator configured to move all or part of the first joint, the second joint, the third joint and the quadrant end joint; and wherein the actuator at said at least one quadrant with four successive limb comprises:
a first motor configured to drive the first joint;
two second motors configured to drive two joints selected from among the second joint, the third joint and the quadrant end joint; and
a constraint system of pulleys and at least one of belts and cables, the constraint system linking the second joint, the third joint and the quadrant end joint.

35. The robotic system of claim 31, wherein the quadrant end joint of said at least one quadrant with four successive limbs is a first pivot connection linking the last limb of said at least one quadrant and the torso of the next quadrant; or wherein the quadrant end joint of said at least one quadrant with four successive limbs comprises a pre-torso, on one hand, linked to the last limb of said at least one quadrant by a second pivot connection configured to enable the rotation about the axis of rotation and, on other hand, linked to the torso of the next quadrant by a connection with no degrees of freedom.

36. The robotic system of claim 35, further comprising at least one locking/unlocking device configured to reversibly detach two successive quadrants;
and wherein, when the quadrant end joint of said at least one quadrant with four successive limbs comprises the pre-torso, said at least one quadrant and the next quadrant are configured to be reversibly detached, at the connection with no degrees of freedom linking the pre-torso to the torso of the next quadrant.

37. The robotic system of claim 22, wherein said at least one quadrant comprises five successive limbs:
the torso;
the shoulder linked to the torso by the first joint;
the arm linked to the shoulder by the second joint,
a forearm linked to the arm by a third joint; and
a fifth limb, referred to as a wrist, linked to the forearm by a fourth joint, the wrist being the last limb.

38. The robotic system of claim 37, wherein:
the third joint is configured to enable a rotation about a third axis, the third axis being parallel to the second axis; and
the fourth joint is configured to enable a rotation about a fourth axis, the fourth axis being parallel to the second axis and to the third axis.

39. The robotic system of claim 37, wherein the quadrant end joint of said at least one quadrant with five successive limbs is configured to enable a rotation about an axis of rotation.

40. The robotic system of claim 39 wherein the axis of rotation is parallel to the first axis of the first joint of the next quadrant.

41. The robotic system of claim 37, further comprising, at said each quadrant, an actuator configured to move all or part of the first joint, the second joint and the quadrant end joint; and wherein the actuator comprises an associated motor for each joint forming the robotic system.

42. The robotic system of claim 40, further comprising, at said each quadrant, an actuator configured to move all or part of the first joint, the second joint and the quadrant end joint; and wherein the actuator at said at least one quadrant with five successive limb comprises:
a first motor configured to drive the first joint;
two second motors configured to drive two joints selected from among the second joint, the third joint and the fourth joint, and
a constraint system of pulleys and at least one of belts and cables, the constraint system linking the second joint, the third joint and the fourth joint.
